(19) United States
(12) Patent Application Publication
(10) Pub. No.: US 2022/0295305 A1
(43) Pub. Date: Sep. 15, 2022

(54) RESOURCE ASSIGNMENT METHOD FOR SIDELINK

(71) Applicant: LG ELECTRONICS INC., Seoul (KR)

(72) Inventors: Jinyup HWANG, Seoul (KR); Youngdae KIM, Seoul (KR); Manyoung JUNG, Seoul (KR); Sangwook LEE, Seoul (KR); Yeongjun KIM, Seoul (KR)

(73) Assignee: LG ELECTRONICS INC., Seoul (KR)

(21) Appl. No.: 17/753,326

(22) PCT Filed: Sep. 1, 2020
(86) PCT No.: PCT/KR2020/011689

§ 371 Date: Feb. 28, 2022

(30) Foreign Application Priority Data
Sep. 6, 2019 (KR) 10-2019-0110796
Sep. 19, 2019 (KR) 10-2019-0115301

(51) Int. Cl. H04W 16/28; H04W 24/10; H04B 17/318

(52) U.S. Cl. CPC H04W 16/28; H04W 24/10; H04B 17/318

(57) ABSTRACT

In order to achieve the above purpose, a disclosure of the present specification provides a method for communicating, by a first transmission terminal, with a first reception terminal. The method may comprise the steps of: receiving, by the first transmission terminal, a measurement report from the first reception terminal, wherein the measurement report includes a result of measuring, by the first reception terminal, a first signal strength from the first transmission terminal and a second signal strength from a second transmission terminal; on the basis of a difference between the first signal strength and the second signal strength, determining whether or not to change and assign a resource to be used for communication with the first reception terminal; and communicating with the first reception terminal by assigning the resource for communication with the first reception terminal.

The present specification relates to mobile communications.

### BACKGROUND

With the success of long term evolution (LTE)/LTE-Advanced (LTE-A) for the fourth-generation mobile communication, the next generation mobile communication, which is the fifth-generation (so called 5G) mobile communication, has been attracting attentions and more and more researches are being conducted.

For the 5G mobile communication, new radio access technology (new RAT or NR) has been researched.

5 G uses a technology that utilizes a high-frequency band called millimeter wave (mmWave) as a mobile communication frequency. In order to utilize a mobile communication service, a radio wave may be directly transmitted to the terminal by using a narrow beam.

On the other hand, terminal devices (smartphones, automobiles, robots, base stations, etc.) supporting these millimeter waves use directional transmission/reception beams to overcome signal attenuation due to high frequency characteristics. In order to transmit and receive a signal through the directional transmit/receive beam, the directional beam of the transmitting terminal and the directional beam of the receiving terminal must coincide with each other. However, when a narrow beam is used, it becomes more difficult to maintain an optimized transmission/reception beam. As a result, interference generated in an adjacent channel increases. In addition, when a strong interference signal enters an adjacent channel, a low power level signal may not be received due to in-channel selectivity (ICS). This causes deterioration of the reception performance of the reception terminal, and there is a problem in that the reception terminal cannot receive a signal when the adjacent channel interference power is greater than the reception power by a certain amount.

### SUMMARY

Therefore, the disclosure of the present specification is to propose method for solving the above-mentioned problems.

In order to achieve the above object, one disclosure of the present specification provides a method in which a first transmitting UE communicates with a first receiving UE. The method comprise receiving, by the first transmitting UE, a measurement report from the first receiving UE, wherein the measurement report includes result of the first receiving terminal measuring a first signal strength from the first transmitting UE and a second signal strength from the second transmitting UE; determining whether to change a resource for allocation to be used for communication with the first receiving UE, based on a difference between the first signal strength and the second signal strength; performing communication by allocating resource for communication with the first receiving UE.

wherein the step of determining whether to change a resource for allocation to be used for communication with the first receiving UE is determining to change a resource for allocation only when the difference between the first signal strength and the second signal strength is greater than or equal to a specific value.

wherein the first signal strength and the second signal strength are measured based on RSRP (Reference Signal Receive Power).

The method further comprises transmitting instruction to measure the first signal strength and the second signal strength to the first receiving UE.

The method further comprises transmitting information on the number of wide beams and the number of narrow beams to the first receiving UE; receiving information on a window section for beam management from the first receiving UE; wherein the step of performing communication by allocating resource for communication with the first receiving UE comprises performing beam sweeping to determine an optimal beam pair.

The method further comprises receiving beam management trigger from the first receiving UE, wherein the step of performing communication by allocating resource for communication with the first receiving UE comprises allocating, by the first transmitting UE, resource by

[symbol]

Therefore, the disclosure of the present specification is to propose method for solving the above-mentioned problems.

### BRIEF DESCRIPTION OF THE DRAWINGS

FIG. 1 is a wireless communication system.

FIG. 2 shows the structure of a radio frame according to FDD in 3GPP LTE.

FIG. 3 shows the cell detection and measurement procedure.

FIGS. 4a to 4c are exemplary diagrams illustrating an exemplary architecture for a service of next-generation mobile communication.

FIG. 5 shows an example of subframe types in NR.

FIGS. 6a and 6b are exemplary views showing the structure of SSB in NR.

FIG. 7 is an exemplary diagram illustrating an example of SSB in NR.

FIG. 8 is an exemplary diagram illustrating an example of beam sweeping in NR.

FIG. 9 shows a measurement and measurement reporting procedure considering an SS burst.

FIG. 10 is an exemplary diagram illustrating a situation in which an optimal reception beam is changed due to movement of a UE.

FIG. 11 is an exemplary diagram illustrating adjacent channel interference.

FIG. 12 illustrates an example in which interference appears.

FIG. 13 is a flowchart illustrating an operation according to a first example of the first disclosure of the present specification.

FIG. 14 is a flowchart illustrating an operation according to a second example of the first disclosure of the present specification.

FIG. 15 is a flowchart illustrating an operation according to a third example of the first disclosure of the present specification.

FIG. 16 illustrates an example in which interference appears.

FIG. 17 is a flowchart illustrating an operation according to one start of beam management according to the first example of the second disclosure.

FIG. 18 is an exemplary diagram illustrating an example of beam management.

FIG. 19 is a flowchart illustrating an exemplary operation of beam management according to a second example of the second disclosure.

FIG. 20 is an exemplary diagram illustrating an example of periodic beam management.

FIG. 21 is an exemplary diagram illustrating an example of aperiodic beam management.

FIG. 22 is an exemplary diagram illustrating another example of aperiodic beam management.

FIG. 23 is a block diagram illustrating a UE and a base station in which the disclosure of the present specification is implemented.

FIG. 24 is a block diagram illustrating a configuration of a UE according to an embodiment.

FIG. 25 is a detailed block diagram of a transceiver of a UE or a base station shown in FIG. 23.

### DETAILED DESCRIPTION

Hereinafter, it is described that the present disclosure is applied based on 3rd Generation Partnership Project (3GPP) 3GPP long term evolution (LTE), 3GPP LTE-A (LTE-Advanced), or 3GPP NR (New RAT). This is merely an example, and the present disclosure can be applied to various wireless communication systems. Hereinafter, LTE includes LTE and/or LTE-A.

The technical terms used herein are used to merely describe specific embodiments and should not be construed as limiting the present specification. Further, the technical terms used herein should be, unless defined otherwise, interpreted as having meanings generally understood by those skilled in the art but not too broadly or too narrowly. Further, the technical terms used herein, which are determined not to exactly represent the spirit of the specification, should be replaced by or understood by such technical terms as being able to be exactly understood by those skilled in the art. Further, the general terms used herein should be interpreted in the context as defined in the dictionary, but not in an excessively narrowed manner.

The expression of the singular number in the present specification includes the meaning of the plural number unless the meaning of the singular number is definitely different from that of the plural number in the context. In the following description, the term ‘include’ or ‘have’ may represent the existence of a feature, a number, a step, an operation, a component, a part or the combination thereof described in the present specification, and may not exclude the existence or addition of another feature, another number, another step, another operation, another component, another part or the combination thereof.

The terms ‘first’ and ‘second’ are used for the purpose of explanation about various components, and the components are not limited to the terms ‘first’ and ‘second’. The terms ‘first’ and ‘second’ are only used to distinguish one component from another component. For example, a first component may be named as a second component without deviating from the scope of the present specification.

It will be understood that when an element or layer is referred to as being “connected to” or “coupled to” another element or layer, it can be directly connected or coupled to the other element or layer or intervening elements or layers may be present. In contrast, when an element is referred to as being “directly connected to” or “directly coupled to” another element or layer, there are no intervening elements or layers present.

Hereinafter, exemplary embodiments of the present specification will be described in greater detail with reference to the accompanying drawings. In describing the present specification, for ease of understanding, the same reference numerals are used to denote the same components throughout the drawings, and repetitive description on the same components will be omitted. Detailed description on well-known arts which are determined to make the gist of the specification unclear will be omitted. The accompanying drawings are provided to merely make the spirit of the specification readily understood, but not should be intended to be limiting of the specification. It should be understood that the spirit of the specification may be expanded to its modifications, replacements or equivalents in addition to what is shown in the drawings.

A base station, a term used below, generally refers to a fixed station that communicates with a wireless device, which may be called other terms such as an evolved-NodeB (eNodeB), an evolved-NodeB (eNB), a BTS (Base Transceiver System), an access point (Access Point).

And hereinafter, the term UE (User Equipment) used herein may be fixed or mobile, and may include a device, a wireless device, a terminal, a mobile station (MS), and a user terminal (UT), SS (subscriber station), MT (mobile terminal), etc. may be called other terms.

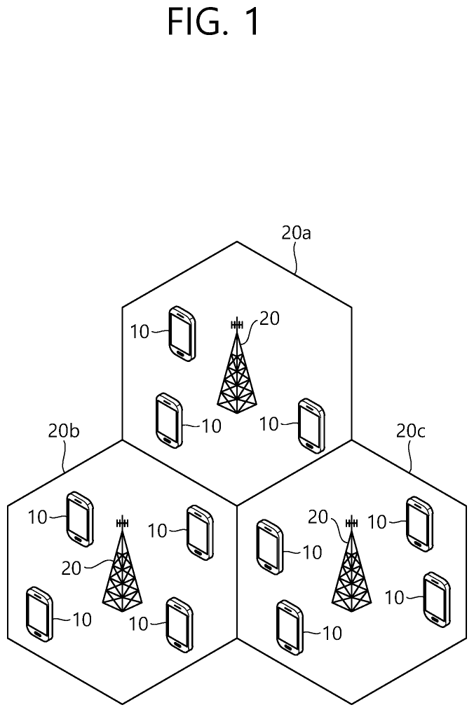

### FIG. 1 is a Wireless Communication System.

As can be seen with reference to FIG. 1, the wireless communication system includes at least one base station (BS) 20. Each base station 20 provides a communication service for a specific geographic area (commonly referred to as a cell) 20a, 20b, 20c. A cell may again be divided into a plurality of regions (referred to as sectors).

A UE typically belongs to one cell, and the cell to which the UE belongs is called a serving cell. A base station providing a communication service to a serving cell is referred to as a serving base station (serving BS). Since the wireless communication system is a cellular system, other cells adjacent to the serving cell exist. The other cell adjacent to the serving cell is referred to as a neighbor cell. A base station that provides a communication service to a neighboring cell is referred to as a neighbor BS. The serving cell and the neighboring cell are relatively determined based on the UE.

Hereinafter, downlink means communication from the base station (20) to the UE (10), and uplink means communication from the UE (10) to the base station (20). In the downlink, the transmitter may be a part of the base station (20), and the receiver may be a part of the UE (10). In the uplink, the transmitter may be a part of the UE (10), and the receiver may be a part of the base station (20).

Meanwhile, a wireless communication system may be largely divided into a frequency division duplex (FDD) scheme and a time division duplex (TDD) scheme. According to the FDD scheme, uplink transmission and downlink transmission are performed while occupying different frequency bands. According to the TDD scheme, uplink transmission and downlink transmission are performed at different times while occupying the same frequency band. The channel response of the TDD scheme is substantially reciprocal. This means that the downlink channel response and the uplink channel response are almost the same in a given frequency domain. Accordingly, in the TDD-based wireless communication system, there is an advantage that the downlink channel response can be obtained from the uplink channel response. In the TDD scheme, since uplink transmission and downlink transmission are time-divided in the entire frequency band, downlink transmission by the base station and uplink transmission by the UE cannot be simultaneously performed. In a TDD system in which uplink transmission and downlink transmission are divided in subframe units, uplink transmission and downlink transmission are performed in different subframes.

Hereinafter, the LTE system will be described in more detail.

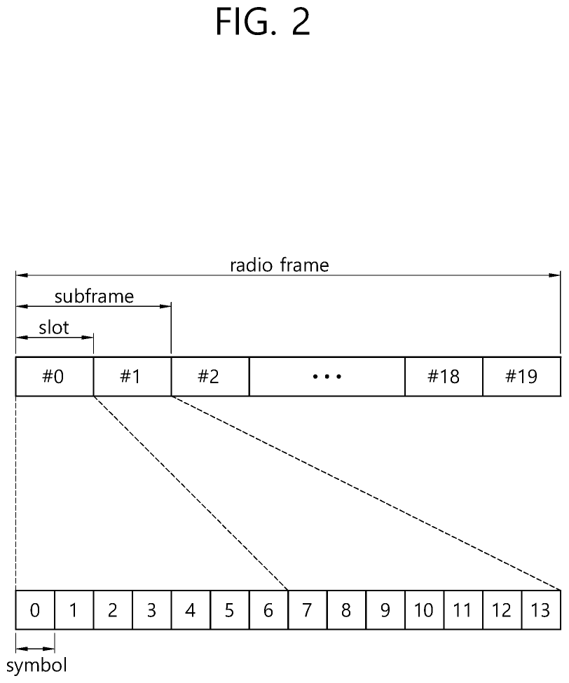

FIG. 2 shows the structure of a radio frame according to FDD in 3 GPP LTE.

Referring to FIG. 2, a radio frame includes 10 subframes, and one subframe includes two slots. The slots in the radio frame are numbered from 0 to 19. The time it takes for one subframe to be transmitted is referred to as a transmission time interval (TTI). The TTI may be referred to as a scheduling unit for data transmission. For example, the length of one radio frame may be 10 ms, the length of one subframe may be 1 ms, and the length of one slot may be 0.5 ms.

The structure of the radio frame is merely an example, and the number of subframes included in the radio frame or the number of slots included in the subframe may be variously changed.

Meanwhile, one slot may include a plurality of orthogonal frequency division multiplexing (OFDM) symbols. How many OFDM symbols are included in one slot may vary according to a cyclic prefix (CP).

One slot includes NRB resource blocks (RBs) in a frequency domain. For example, in the LTE system, the number of resource blocks (RBs), that is, NRB may be any one of 6 to 110.

A resource block (RB) is a resource allocation unit and includes a plurality of subcarriers in one slot. For example, if one slot includes 7 OFDM symbols in the time domain and the resource block includes 12 subcarriers in the frequency domain, one resource block may include 7*12 resource elements (REs).

In 3 GPP LTE, physical channels are divided into data channels, such as PDSCH (Physical Downlink Shared Channel) and PUSCH (Physical Uplink Shared Channel), and control channels, such as PDCCH (Physical Downlink Control Channel), PCFICH (Physical Control Format Indicator Channel), PHICH (Physical Hybrid-ARQ Indicator Channel) and PUCCH (Physical Uplink Control Channel).

The uplink channel includes PUSCH, PUCCH, SRS(Sounding Reference Signal), and PRACH(Physical Random Access Channel).

### <Measurement and Measurement Report>

In a mobile communication system, support for mobility of the UE 100 is essential. Accordingly, the UE 100 continuously measures the quality of the serving cell providing the current service and the quality of the neighboring cell. The UE 100 reports the measurement result to the network at an appropriate time, and the network provides optimal mobility to the UE through handover or the like. Measurements for this purpose are often referred to as radio resource management (RRM) measurements.

Meanwhile, the UE 100 monitors the downlink quality of the primary cell (Pcell) based on the CRS. This is called RLM (Radio Link Monitoring).

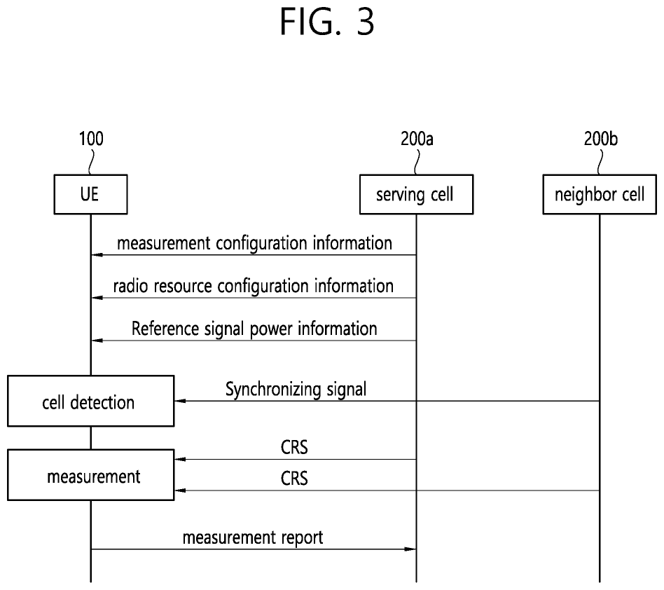

FIG. 3 shows the cell detection and measurement procedure.

As can be seen with reference to FIG. 3, the UE detects a neighboring cell based on a synchronization signal (SS) transmitted from the neighboring cell. The SS may include a Primary Synchronization Signal (PSS) and a Secondary Synchronization Signal (SSS).

And, when the serving cell 200a and the neighbor cell 200b each transmit a CRS (Cell-specific Reference Signal) to the UE 100, the UE 100 performs measurement through the CRS, and the measurement result is transmitted to the serving cell 200a. In this case, the UE 100 compares the power of the received CRS based on information on the received reference signal power.

In this case, the UE 100 may perform measurement in the following three methods.

1) RSRP (reference signal received power): Indicates the average received power of all REs carrying CRS transmitted over the entire band. At this time, instead of CRS, the average received power of all REs carrying CSI (Channel State Information)-RS (Reference Signal) may be measured.

2) RSSI (received signal strength indicator): indicates received power measured in the entire band. RSSI includes signals, interference, and thermal noise.

3) RSRQ (reference symbol received quality): indicates CQI, and may be determined as RSRP/RSSI according to a measurement bandwidth or subband. That is, RSRQ means a signal-to-noise interference ratio (SINR). Since RSRP does not provide sufficient mobility information, RSRQ may be used instead of RSRP in a handover or cell reselection process.

It can be calculated as RSRQ=RSSI/RSSP.

On the other hand, as shown, the UE 100 receives a radio resource configuration (Radio Resource Configuration) information element (IE: Information Element) from the serving cell (100a) for the measurement. The Radio Resource Configuration Dedicated (IE) information element (IE) is used for setting/modifying/releasing a radio bearer, or modifying a MAC configuration. The radio resource configuration IE includes subframe pattern information. The subframe pattern information is information on a measurement resource restriction pattern on the time domain for measuring RSRP and RSRQ for a serving cell (eg, a primary cell).

Meanwhile, the UE 100 receives a measurement configuration (hereinafter, also referred to as ‘measconfig’) information element (IE) from the serving cell 100a for the measurement. A message including a measurement configuration information element (IE) is referred to as a measurement configuration message. Here, the measurement configuration information element (IE) may be received through an RRC connection reconfiguration message. If the measurement result satisfies the reporting condition in the measurement configuration information, the UE reports the measurement result to the base station. A message including the measurement result is called a measurement report message.

The measurement setting IE may include measurement object information. The measurement object information is information about an object on which the UE performs measurement. The measurement object includes at least one of an intra-frequency measurement object that is an intra-cell measurement object, an inter-frequency measurement object that is an inter-cell measurement object, and an inter-RAT measurement object that is an inter-RAT measurement object. For example, the intra-frequency measurement object indicates a neighboring cell having the same frequency band as the serving cell, the inter-frequency measurement object indicates a neighboring cell having a different frequency band from the serving cell, and the inter-RAT measurement object is A neighboring cell of a RAT different from the RAT of the serving cell may be indicated.

TABLE 1
Measurement Object Field Descriptions

carrierFreq
Indicates the E-UTRA carrier frequency to which this setting applies.
measCycleSCell
Indicates a cycle for measuring the SCell in an inactive state. The value may be set to 160,
256., etc. When the value is 160, it indicates that measurement is performed every 160
subframes.

On the other hand, the measurement configuration IE includes an IE (information element) as shown in the table below.

TABLE 2
MeasConfig Field Descriptions

allowInterruptions
When the value is True, this indicates that transmission and reception with the serving cell is
MeasConfig Field Descriptions
allowed to stop when the UE performs measurement using MeasCycleScell on carriers of the
deactivated Scell.
measGapConfig
Setting or disabling the measurement gap

The measGapConfig is used to set or release a measurement gap (MG). The measurement gap MG is a period for performing cell identification and RSRP measurement on a frequency different from that of the serving cell.

TABLE 3
MeasGapConfig Field Descriptions

Any one of gp0, gp1, gp2, and gp3 may be set as the value of gapOffset. gp0 corresponds to the
gap offset of pattern ID “0” with MGRP = 40 ms. Gp1 corresponds to the gap offset of pattern ID
&quot;1&quot; with MGRP = 80 ms. gp2 corresponds to the gap offset of pattern ID “2” with
MGRP = 40 ms and MGL = 3 ms. gp3 corresponds to the gap offset of pattern ID “3” with
MGRP = 80 ms and MGL = 3 ms.

TABLE 4

| | | | Minimum time to perform |
|---|---|---|---|
| | | Measurement Gap | measurements for inter-frequency |
| Gap | Measurement Gap | Repetition Period: | and inter-RAT during 480 ms |
| Pattern Id | Length: MGL | MGRP | interval |
| 0 | 6 ms | 40 ms | 60 ms |
| 1 | 6 ms | 80 ms | 30 ms |
| 2 | 3 ms | 40 ms | 24 ms |
| 3 | 3 ms | 80 ms | 12 ms |

If the UE requires a measurement gap to identify and measure inter-frequency and inter-RAT cells, the E-UTRAN (ie, the base station) provides one measurement gap (MG) pattern having a constant gap interval. The UE does not transmit/receive any data from the serving cell during the measurement gap period, and after retuning its RF chain according to the inter-frequency, performs measurement at the corresponding inter-frequency.

### <Carrier Aggregation>

A carrier aggregation (CA) system will now be described.

The carrier aggregation system refers to aggregation of a plurality of component carriers (CCs). By such carrier aggregation, the meaning of an existing cell is changed. According to carrier aggregation, a cell may mean a combination of a downlink component carrier and an uplink component carrier, or a single downlink component carrier.

In addition, in carrier aggregation, a cell may be divided into a primary cell, a secondary cell, and a serving cell. A primary cell means a cell operating at a primary frequency, and a cell in which the UE performs an initial connection establishment procedure or a connection re-establishment procedure with a base station, or is indicated as a primary cell in a handover procedure means cell. The secondary cell refers to a cell operating in a secondary frequency, is established once an RRC connection is established, and is used to provide additional radio resources.

As described above, the carrier aggregation system may support a plurality of CCs, that is, a plurality of serving cells, unlike the single carrier system.

Such a carrier aggregation system may support cross-carrier scheduling. Cross-carrier scheduling refers to resource allocation of a PDSCH transmitted through another component carrier through a PDCCH transmitted through a specific component carrier and/or a component other than a component carrier that is basically linked to the specific component carrier. It is a scheduling method capable of allocating resources of PUSCH transmitted through a carrier.

### <Introduction of Dual Connectivity (DC)>

Recently, a method for allowing a UE to simultaneously connect to different base stations, for example, a base station of a macro cell and a base station of a small cell, is being studied. This is called double connection (DC).

In DC, an eNodeB for a primary cell (Pcell) may be referred to as a Master eNodeB (hereinafter, referred to as MeNB). In addition, the eNodeB for only the secondary cell (Scell) may be referred to as a secondary eNodeB (hereinafter, referred to as SeNB).

A cell group including a primary cell (Pcell) by the MeNB may be referred to as a master cell group (MCG) or a PUCCH cell group 1, and a cell group including a secondary cell (Scell) by the SeNB may be referred to as a secondary cell group (SCG) or a PUCCH cell group 2.

On the other hand, among the secondary cells in the secondary cell group (SCG), a secondary cell capable of transmitting UCI (Uplink Control Information) or a secondary cell capable of transmitting PUCCH to a UE is a super secondary cell (Super SCell) or a primary secondary cell (PSCell).

### <IoT (Internet of Things) Communication>

Meanwhile, the IoT will be described below.

The IoT refers to information exchange between IoT devices without human interaction through a base station or information exchange between an IoT device and a server through a base station. In this way, since IoT communication passes through a cellular base station, it is also called CIoT (Cellular Internet of Things).

Such IoT communication is a type of MTC (Machine Type Communication). Accordingly, the IoT device may be referred to as an MTC device.

Since IoT communication has a small amount of transmitted data and infrequent transmission and reception of uplink or downlink data, it is desirable to lower the unit price of the IoT device and reduce battery consumption according to a low data rate. In addition, since the IoT device has low mobility, it has a characteristic that the channel environment hardly changes.

As one method for low-cost of the IoT device, regardless of the system bandwidth of the cell, the IoT device may use a subband (subband) of, for example, about 1.4 MHz.

The IoT communication operating on the reduced bandwidth may be referred to as NB (Narrow Band) IoT communication or NB CIoT communication.

### <Next-Generation Mobile Communication Network>

Thanks to the success of LTE (long term evolution)/LTE-Advanced (LTE-A) for 4^{th} generation mobile communication, interest in next-generation, that is, 5^{th} generation (so-called 5G) mobile communication is increasing, and research is being conducted one after another.

5G mobile communication, defined by the International Telecommunication Union (ITU), refers to providing a data transmission rate of up to 20 Gbps and a perceived transmission speed of at least 100 Mbps anywhere. The official name is ‘IMT- 2020’, and it aims to commercialize it worldwide in 2020.

The ITU proposes three usage scenarios, for example, eMBB(enhanced Mobile

BroadBand), mMTC(massive Machine Type Communication) and URLLC(Ultra Reliable and Low Latency Communications).

URLLC relates to usage scenarios that require high reliability and low latency. For example, services such as autonomous driving, factory automation, and augmented reality require high reliability and low latency (eg, latency of 1 ms or less). Currently, the delay time of 4G (LTE) is statistically 21-43 ms (best 10 %) and 33-75 ms (median). This is insufficient to support services requiring latency of less than 1 ms. Next, the eMBB usage scenario relates to a usage scenario requiring mobile ultra-wideband.

That is, the 5^{th} generation mobile communication system may target higher capacity than the current 4G LTE, increase the density of mobile broadband users, and support D2D (Device to Device), high stability, and MTC (Machine type communication). 5G R&D also aims to achieve lower latency and lower battery consumption than 4G mobile communication systems to better realize the Internet of Things. For such 5G mobile communication, a new radio access technology (New RAT or NR) may be proposed.

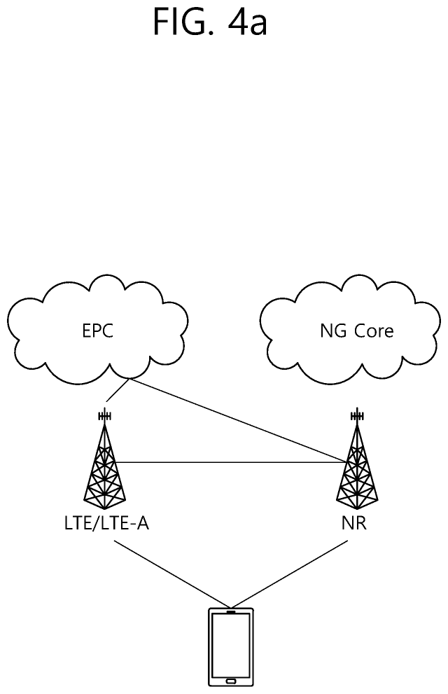

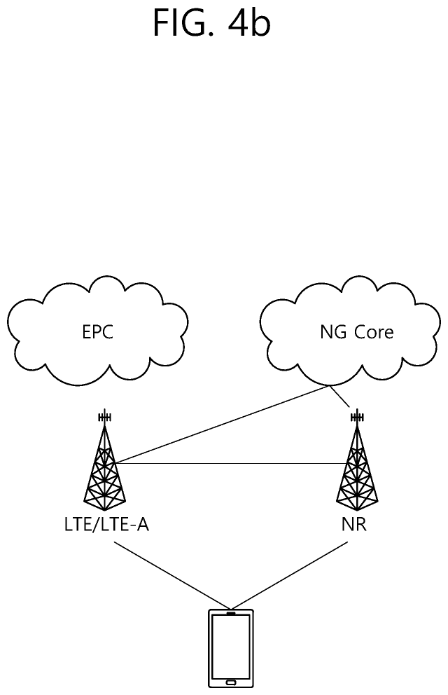

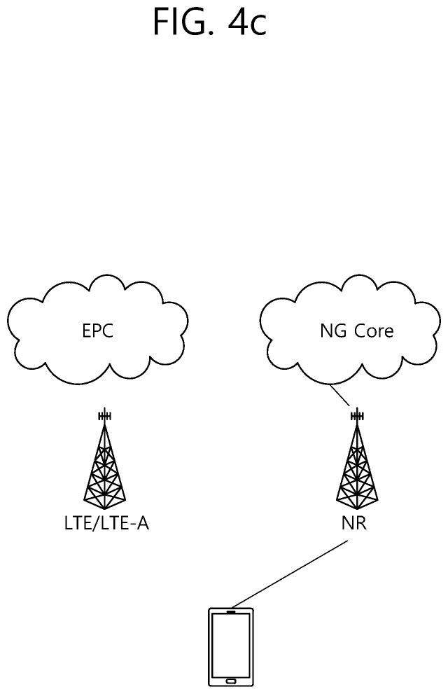

FIGS. 4a to 4c are exemplary diagrams illustrating an exemplary architecture for a service of next-generation mobile communication.

Referring to FIG. 4a , the UE is connected to the LTE/LTE-A-based cell and the NR-based cell in a DC (dual connectivity) manner.

The NR-based cell is connected to a core network for the existing 4G mobile communication, that is, the NR-based cell is connected an Evolved Packet Core (EPC).

Referring to FIG. 4b , unlike FIG. 4a , an LTE/LTE-A-based cell is connected to a core network for 5G mobile communication, that is, the LTE/LTE-A-based cell is connected to a Next Generation (NG) core network.

A service method based on the architecture shown in FIG. 4a and FIG. 4b is referred to as NSA(non-standalone).

Referring to FIG. 4c, UE is connected only to an NR-based cell. A service method based on this architecture is called SA(standalone).

Meanwhile, in the NR, it may be considered that reception from a base station uses downlink subframe, and transmission to a base station uses uplink subframe. This method can be applied to paired and unpaired spectra. A pair of spectrum means that two carrier spectrums are included for downlink and uplink operation. For example, in a pair of spectrums, one carrier may include a downlink band and an uplink band that are paired with each other.

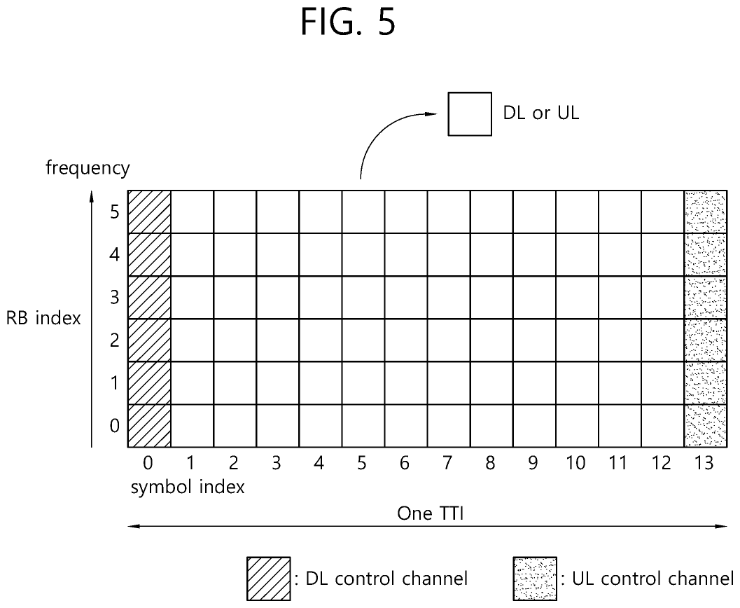

FIG. 5 shows an example of subframe types in NR.

The TTI(transmission time interval) shown in FIG. 5 may be referred to as a subframe or a slot for NR (or new RAT). The subframe (or slot) of FIG. 5 may be used in a TDD system of NR (or new RAT) to minimize data transmission delay. As shown in FIG. 5, a subframe (or slot) includes 14 symbols, like the current subframe. The front symbol of the subframe (or slot) may be used for the DL control channel, and the rear symbol of the subframe (or slot) may be used for the UL control channel. The remaining symbols may be used for DL data transmission or UL data transmission. According to this subframe (or slot) structure, downlink transmission and uplink transmission may be sequentially performed in one subframe (or slot). Accordingly, downlink data may be received within a subframe (or slot), and uplink acknowledgment (ACK/NACK) may be transmitted within the subframe (or slot). The structure of such a subframe (or slot) may be referred to as a self-contained subframe (or slot). When the structure of such subframe (or slot) is used, the time it takes to retransmit data in which a reception error occurs is reduced, so that the final data transmission latency can be minimized. In such a self-contained subframe (or slot) structure, a time gap, from the transmission mode to the reception mode or from the reception mode to the transmission mode, may be required in a transition process. To this, some OFDM symbols when switching from DL to UL in the subframe structure may be set as a guard period (GP).

### <Support of Various Numerologies>

In the next generation system, with development of wireless communication technologies, a plurality of numerologies may be provided to a UE.

The numerologies may be defined by a length of cycle prefix (CP) and a subcarrier spacing. One cell may provide a plurality of numerology to a UE. When an index of a numerology is represented by μ, a subcarrier spacing and a corresponding CP length may be expressed as shown in the following table.

TABLE 5

| M | Δf = 2μ · 15 [kHz] | CP |
|---|---|---|
| 0 | 15 | Normal |
| 1 | 30 | Normal |
| 2 | 60 | Normal, Extended |
| 3 | 120 | Normal |
| 4 | 240 | Normal |

In the case of a normal CP, when an index of a numerology is expressed by μ, the number of OLDM symbols per slot Nslotsymb, the number of slots per frame Nframe,μslot, and the number of slots per subframe Nsubframe,μslot are expressed as shown in the following table.

TABLE 6

| μ | N^{slot}_{symb} | N^{frame, μ}ₛₗₒₜ | N^{subframe, μ}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

In the case of an extended CP, when an index of a numerology is represented by μ, the number of OLDM symbols per slot Nslotsymb, the number of slots per frame Nframe,μslot, and the number of slots per subframe Nsubframe,μslot are expressed as shown in the following table.

TABLE 7

| M | N^{slot}_{symb} | N^{frame, μ}ₛₗₒₜ | N^{subframe, μ}ₛₗₒₜ |
|---|---|---|---|
| 2 | 12 | 40 | 4 |

Meanwhile, in the next-generation mobile communication, each symbol may be used for downlink or uplink, as shown in the following table. In the following table, uplink is indicated by U, and downlink is indicated by D. In the following table, X indicates a symbol that can be flexibly used for uplink or downlink.

TABLE 8

| | Symbol Number in Slot | | | | | | | | | | | | | |
|---|---|---|---|---|---|---|---|---|---|---|---|---|---|---|
| Format | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | X | X | X | X | X | X | X | X | X | X | X | X | X | X |
| 3 | D | D | D | D | D | D | D | D | D | D | D | D | D | X |
| 4 | D | D | D | D | D | D | D | D | D | D | D | D | X | X |
| 5 | D | D | D | D | D | D | D | D | D | D | D | X | X | X |
| 6 | D | D | D | D | D | D | D | D | D | D | X | X | X | X |
| 7 | D | D | D | D | D | D | D | D | D | X | X | X | X | X |
| 8 | X | X | X | X | X | X | X | X | X | X | X | X | X | U |
| 9 | X | X | X | X | X | X | X | X | X | X | X | X | U | U |
| 10 | X | U | U | U | U | U | U | U | U | U | U | U | U | U |
| 11 | X | X | U | U | U | U | U | U | U | U | U | U | U | U |
| 12 | X | X | X | U | U | U | U | U | u | U | U | U | U | U |
| 13 | X | X | X | X | U | U | U | U | U | U | U | U | U | U |
| 14 | X | X | X | X | X | U | U | U | U | U | U | U | U | U |
| 15 | X | X | X | X | X | X | U | U | U | U | U | U | U | U |
| 16 | D | X | X | X | X | X | X | X | X | X | X | X | X | X |
| 17 | D | D | X | X | X | X | X | X | X | X | X | X | X | X |
| 18 | D | D | D | X | X | X | X | X | X | X | X | X | X | X |
| 19 | D | X | X | X | X | X | X | X | X | X | X | X | X | U |
| 20 | D | D | X | X | X | X | X | X | X | X | X | X | X | U |
| 21 | D | D | D | X | X | X | X | X | X | X | X | X | X | U |
| 22 | D | X | X | X | X | X | X | X | X | X | X | X | U | U |
| 23 | D | D | X | X | X | X | X | X | X | X | X | X | U | U |
| 24 | D | D | D | X | X | X | X | X | X | X | X | X | U | U |
| 25 | D | X | X | X | X | X | X | X | X | X | X | U | U | U |
| 26 | D | D | X | X | X | X | X | X | X | X | X | U | U | U |
| 27 | D | D | D | X | X | X | X | X | X | X | X | U | U | U |
| 28 | D | D | D | D | D | D | D | D | D | D | D | D | X | U |
| 29 | D | D | D | D | D | D | D | D | D | D | D | X | X | U |
| 30 | D | D | D | D | D | D | D | D | D | D | X | X | X | U |
| 31 | D | D | D | D | D | D | D | D | D | D | D | X | U | U |
| 32 | D | D | D | D | D | D | D | D | D | D | X | X | U | U |
| 33 | D | D | D | D | D | D | D | D | D | X | X | X | U | U |
| 34 | D | X | U | U | U | U | U | U | U | U | U | U | U | U |
| 35 | D | D | X | U | U | U | U | U | U | U | U | U | U | U |
| 36 | D | D | D | X | U | U | U | U | U | U | U | U | U | U |
| 37 | D | X | X | U | U | U | U | U | U | U | U | U | U | U |
| 38 | D | D | X | X | U | U | U | U | U | U | U | U | U | U |
| 39 | D | D | D | X | X | U | U | U | U | U | U | U | U | U |
| 40 | D | X | X | X | U | U | U | U | U | U | U | U | U | U |
| 41 | D | D | X | X | X | U | U | U | U | U | U | U | U | U |
| 42 | D | D | D | X | X | X | U | U | U | U | U | U | U | U |
| 43 | D | D | D | D | D | D | D | D | D | X | X | X | X | U |
| 44 | D | D | D | D | D | D | X | X | X | X | X | X | U | U |
| 45 | D | D | D | D | D | D | X | X | U | U | U | U | U | U |
| 46 | D | D | D | D | D | D | X | D | D | D | D | D | D | X |
| 47 | D | D | D | D | D | X | X | D | D | D | D | D | X | X |
| 48 | D | D | X | X | X | X | X | D | D | X | X | X | X | X |
| 49 | D | X | X | X | X | X | X | D | X | X | X | X | X | X |
| 50 | X | U | U | U | U | U | U | X | U | U | U | U | U | U |
| 51 | X | X | U | U | U | U | U | X | X | U | U | U | U | U |
| 52 | X | X | X | U | U | U | U | X | X | X | U | U | U | U |
| 53 | X | X | X | X | U | U | U | X | X | X | X | U | U | U |
| 54 | D | D | D | D | D | X | U | D | D | D | D | D | X | U |
| 55 | D | D | X | U | U | U | U | D | D | X | U | U | U | U |
| 56 | D | X | U | U | U | U | U | D | X | U | U | U | U | U |
| 57 | D | D | D | D | X | X | U | D | D | D | D | X | X | U |
| 58 | D | D | X | X | U | U | U | D | D | X | X | U | U | U |
| 59 | D | X | X | U | U | U | U | D | X | X | U | U | U | U |
| 60 | D | X | X | X | X | X | U | D | X | X | X | X | X | U |
| 61 | D | D | X | X | X | X | U | D | D | X | X | X | X | U |

### <Operating Band in NR>

The operating band in NR is divided into a frequency range 1 (FR 1) band and an FR 2 band. The FR 1 band means a frequency band of 6 GHz or less, and the FR 2 band means a frequency band of more than 6 GHz. FR 1 band and FR 2 band are defined as shown in Table 9 below.

TABLE 9

| Frequency band designation | Corresponding frequency range |
|---|---|
| Frequency Range 1 (FR 1) | 450 MHz-6000 MHz |
| Frequency Range 2 (FR 2) | 24250 MHz-52600 MHz |

The operating bands in Table 10 below are operating bands converted from the LTE/LTE-A operating band and correspond to the FR 1 band.

TABLE 10

| NR | Uplink | Downlink | |
|---|---|---|---|
| operation | operation bands | operation bands | Duplex |
| bands | F_{UL}_{_{—}}_{low}-F_{UL}_{_{—}}_{high} | F_{DL}_{_{—}}_{low}-F_{DL}_{_{—}}_{high} | mode |
| n1 | 1920 MHz-1980 MHz | 2110 MHz-2170 MHz | FDD |
| n2 | 1850 MHz-1910 MHz | 1930 MHz-1990 MHz | FDD |
| n3 | 1710 MHz-1785 MHz | 1805 MHz-1880 MHz | FDD |
| n5 | 824 MHz-849 MHz | 869 MHz-894 MHz | FDD |
| n7 | 2500 MHz-2570 MHz | 2620 MHz-690 MHz | FDD |
| n8 | 880 MHz-915 MHz | 925 MHz-960 MHz | FDD |
| n20 | 832 MHz-862 MHz | 791 MHz-821 MHz | FDD |
| n28 | 703 MHz-748 MHz | 758 MHz-803 MHz | FDD |
| n38 | 2570 MHz-2620 MHz | 2570 MHz-2620 MHz | TDD |
| n41 | 2496 MHz-2690 MHz | 2496 MHz-2690 MHz | TDD |
| n50 | 1432 MHz-1517 MHz | 1432 MHz-1517 MHz | TDD |
| n51 | 1427 MHz-1432 MHz | 1427 MHz-1432 MHz | TDD |
| n66 | 1710 MHz-1780 MHz | 2110 MHz-2200 MHz | FDD |
| n70 | 1695 MHz-1710 MHz | 1995 MHz-2020 MHz | FDD |
| n71 | 663 MHz-698 MHz | 617 MHz-652 MHz | FDD |
| n74 | 1427 MHz-1470 MHz | 1475 MHz-1518 MHz | FDD |
| n75 | N/A | 1432 MHz-1517 MHz | SDL |
| n76 | N/A | 1427 MHz-1432 MHz | SDL |
| n77 | 3300 MHz-4200 MHz | 3300 MHz-4200 MHz | TDD |
| n78 | 3300 MHz-3800 MHz | 3300 MHz-3800 MHz | TDD |
| n79 | 4400 MHz-5000 MHz | 4400 MHz-5000 MHz | TDD |
| n80 | 1710 MHz-1785 MHz | N/A | SUL |
| n81 | 880 MHz-915 MHz | N/A | SUL |
| n82 | 832 MHz-862 MHz | N/A | SUL |
| n83 | 703 MHz-748 MHz | N/A | SUL |
| n84 | 1920 MHz-1980 MHz | N/A | SUL |

Below Table 11 shows the NR operating bands defined in the high frequency phase, and the operating bands in Table 11 correspond to the FR 2 band.

TABLE 11

| NR | Uplink (UL) | Downlink (DL) | |
|---|---|---|---|
| operation | operating band | operating band | duplex |
| band | F_{UL}_{_{—}}_{low}-F_{UL}_{_{—}}_{high} | F_{DL}_{_{—}}_{low}-F_{DL}_{_{—}}_{high} | mode |
| n257 | 26500 MHz-29500 MHz | 26500 MHz-29500 MHz | TDD |
| n258 | 24250 MHz-27500 MHz | 24250 MHz-27500 MHz | TDD |
| n259 | 37000 MHz-40000 MHz | 37000 MHz-40000 MHz | TDD |

On the other hand, when the operating band of the above table is used, it is used as the channel bandwidth as shown in the following table.

TABLE 12

| | 5 | 10 | 15 | 20 | 25 | 30 | 40 | 50 | 60 | 80 | 100 |
|---|---|---|---|---|---|---|---|---|---|---|---|
| SCS | MHz | MHz | MHz | MHz | MHz | MHz | MHz | MHz | MHz | MHz | MHz |
| (kHz) | N_{RB} | N_{RB} | N_{RB} | N_{RB} | N_{RB} | N_{RB} | N_{RB} | N_{RB} | N_{RB} | N_{RB} | N_{RB} |
| 15 | 25 | 52 | 79 | 106 | 133 | [160] | 216 | 270 | N/A | N/A | N/A |
| 30 | 11 | 24 | 38 | 51 | 65 | [78] | 106 | 133 | 162 | 217 | 273 |
| 60 | N/A | 11 | 18 | 24 | 31 | [38] | 51 | 65 | 79 | 107 | 135 |

In the above Table 12, SCS means subcarrier spacing. In the above table, NRB indicates the number of RBs. On the other hand, when the operating band of the above table is used, it is used as the channel bandwidth as shown in below Table 13.

TABLE 13

| SCS | 50 MHz | 100 MHz | 200 MHz | 400 MHz |
|---|---|---|---|---|
| (kHz) | N_{RB} | N_{RB} | N_{RB} | N_{RB} |
| 60 | 66 | 132 | 264 | N.A |
| 120 | 32 | 66 | 132 | 264 |

### <CSI-RS>

The CSI-RS is a channel-state information (CSI) reference signal (CSI-Reference Signal). The CSI-RS is a reference signal used when the UE reports to a serving cell related to CSI feedback.

The CSI-RS may be configured by a combination of one or more CSI-RS components. Zero-power CSI-RS and non-zero-power CSI are defined.

For non-zero-power CSI-RS, a sequence is generated according to 7.4.1.5.2 of 3 GPP

TS 38.211 and mapped to a resource element according to 7.4.1.5.3.

For zero-power CSI-RS, the UE assumes that the resource elements defined in 7.4.1.5.3 of 3 GPP TS 38.211 are not used for PDSCH transmission, and makes no assumptions about downlink transmission within these resource elements.
CSI-RS location within the slot

1) Frequency location: The starting subcarrier of the component RE pattern is as follows.
For 1-port CSI-RS, there is no restriction.
for Y=2, limited to one of the even subcarriers.
For Y=4, it is limited to one of subcarriers 0, 4, 8.

Here, Y means an interval at which the start subcarrier is arranged.

2) Time location: Transmitted in 5, 6, 7, 8, 9, 10, 12, 13 OFDM symbols.
Cycle

In NR, the following CSI-RS transmission period is supported.

{5, 10, 20, 40, 80, 160, 320, 640} slots

### <NR to SS Block>

SS block (SS/PBCH block: SSB) is information necessary for the terminal to perform initial access in 5G NR, that is, a physical broadcast channel (PBCH) including a master information block (MIB) and a synchronization signal (Synchronization Signal: SS) (PSS and SSS).

In addition, a plurality of SSBs may be bundled to define an SS burst, and a plurality of SS bursts may be bundled to define an SS burst set. It is assumed that each SSB is beamformed in a specific direction, and several SSBs in the SS burst set are designed to support terminals existing in different directions, respectively.

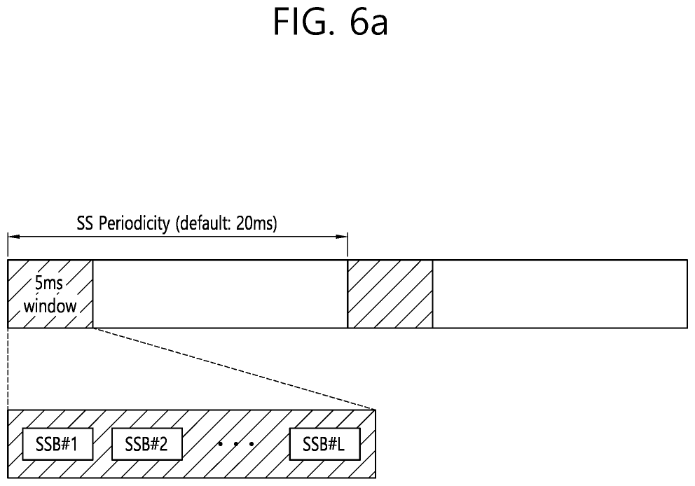

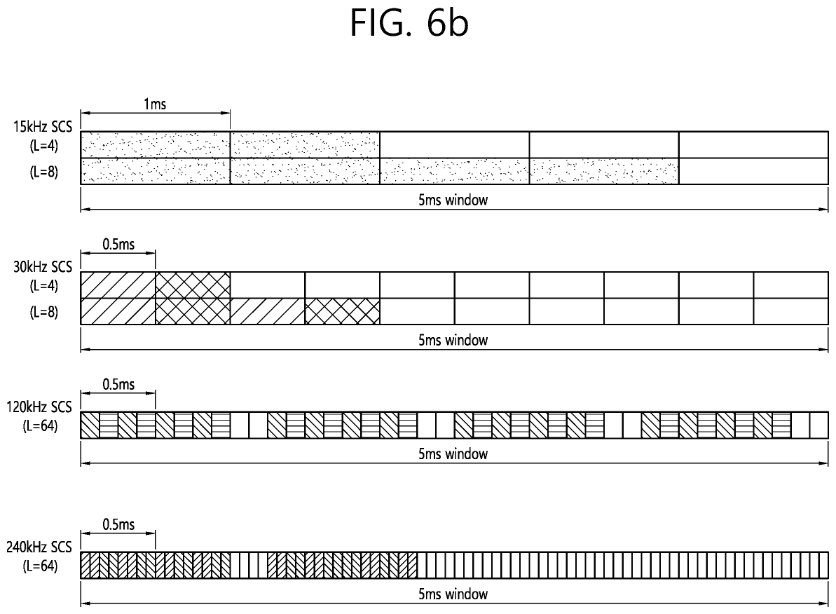

FIGS. 6a and 6b are exemplary views showing the structure of SSB in NR.

Referring to FIGS. 6a and 6b, the SSBs in the SS burst may be transmitted within a window of 5 ms length regardless of the period of the SS burst set. Within the 5 ms window, the number of possible candidates in which the SSB may be located may be L.

For various frequency bands, the maximum number L of SSBs in an SS burst set may be as in the following example. (For reference, it is assumed that the minimum number of SSBs in each SS burst set is 1 to define a performance requirement)
Frequency band below 3 GHz: L=4
3 GHz˜6 GHZ frequency band: L=8
6 GHz˜52.6 GHz frequency band: L=64

And, as shown in FIG. 6a , the SSB period may be 20 ms. Specifically, a default value for initial cell selection may be 20 ms. And, in RRC CONNECTED/RRC IDLE and NSA, the SSB period may be, for example, one of {5, 10, 20, 40, 80, 160}ms.

FIG. 6B shows an example of SSB configuration within a 5 ms window. Referring to FIG. 6, an example of SSB according to subcarrier spacing (SCS) and an L value in each SCS is shown. In FIG. 6b , two SSBs may be located in each colored area. For example, when L=4 in 15 kHz SCS, two SSBs are respectively located in two colored areas, so that a total of four SSBs can be transmitted in a 5 ms window. As another example, when L=64 in 240 kHZSCS, each SSB is located in 32 colored areas, so that a total of 64 SSBs can be transmitted in a 5 ms window.

### Time-Frequency Structure of an SS/PBCH Block

In the time domain, the SSB may consist of 4 OFDM symbols. Here, the four OFDM symbols may be numbered from 0 to 3 in ascending order within the SSB. Within SSB, PSS, SSS and PBCH (related to DM-RS) may use OFDM symbols.

In the frequency domain, the SSB may include 240 consecutive subcarriers. Here, subcarriers may be numbered from 0 to 239 in the SSB. It is assumed that k is a frequency index, 1 is a time index, and k and 1 may be defined in one SSB.

The UE may assume that a resource element indicated by “set to 0” in the example of Table 14 is set to 0. Subcarrier 0 in the SSB may correspond to the subcarrier k0 of a common resource block [symbol] Here, the [symbol] may be obtained by the UE through higher layer signaling. For example, the [symbol] may be obtained from a higher-layer parameter offset-ref-low-scs-ref-PRB. Any common resource block partially or entirely overlapped with the SSB may be viewed as occupied or not used for transmission of the PDSCH or PDCCH. A resource element that is not used for SSB transmission but is part of a partially overlapping common resource may be assumed to be set to 0.

For SSB, the UE can estimate the following.
Antenna port p-4000
The same CP length and SCS may be used for PSS, SSS and PBCH.
for a specific SSB type (eg, SSB type A), k0∈{0, 1, 2, . . . , 23}, μ∈{0, 1}, and [symbol] may be expressed in units of 15 kHz SCS.
for a specific SSB type (eg, SSB type B), k0∈{0, 1, 2, . . . , 11}, μ∈{3, 4}, and [symbol] may be expressed in units of 60 kHz SCS.

The UE determines that the SSB transmitted with the same block index is QCL for Doppler spread, Doppler shift, average gain, average delay, and spatial Rx parameters (Doppler spread, Doppler shift, average gain, average delay, and spatial Rx parameters). (quasi co-located). The UE may not assume QCL for other SSB transmissions.

Table 14 below shows examples of resources in SSB for PSS, SSS, PBCH and DM-RS for PBCH in SSB.

TABLE 14

| | number of OFDM | |
|---|---|---|
| | symbols for | |
| channel or | the starting | Number of subcarriers for the |
| signal | point of SSB: 1 | starting point of SSB: k |
| PSS | 0 | 56, 57, . . . , 182 |
| SSS | 2 | 56, 57, . . . , 182 |
| Set to 0 | 0 | 0, 1, . . . , 55, 183, 184, . . . , 236 |
| | 2 | 48, 49, . . . , 55, 183, 184, . . . , 191 |
| PBCH | 1, 3 | 0, 1, . . . , 239 |
| | 2 | 0, 1, . . . , 47, |
| | | 192, 193, . . . , 239 |
| DM-RS for | 1, 3 | 0 + υ, 4 + υ, 8 + υ, . . . , 236 + υ |
| PBCH | | |
| | 2 | 0 + υ, 4 + υ, 8 + υ, . . . , 44 + υ |
| | | 192 + υ, 196 + υ, . . . , 236 + υ |

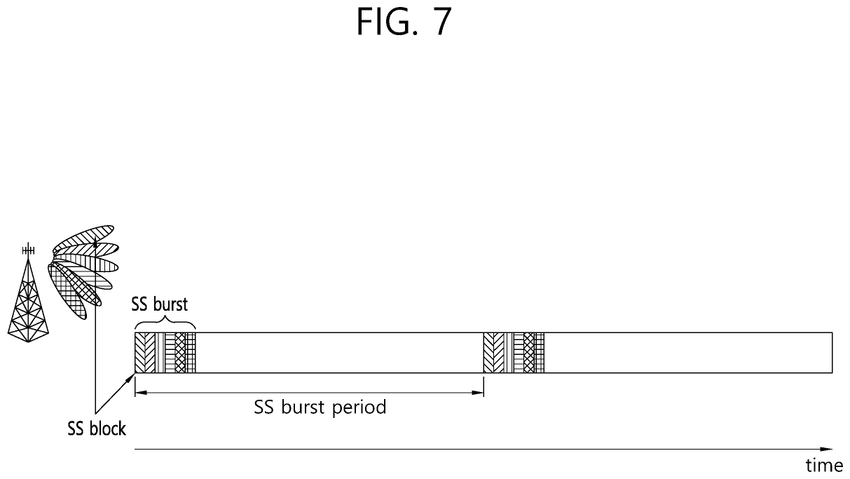

FIG. 7 is an exemplary diagram illustrating an example of SSB in NR.

Referring to FIG. 7, the SS burst is transmitted every predetermined period. Accordingly, the terminal receives the SSB, and performs cell detection and measurement.

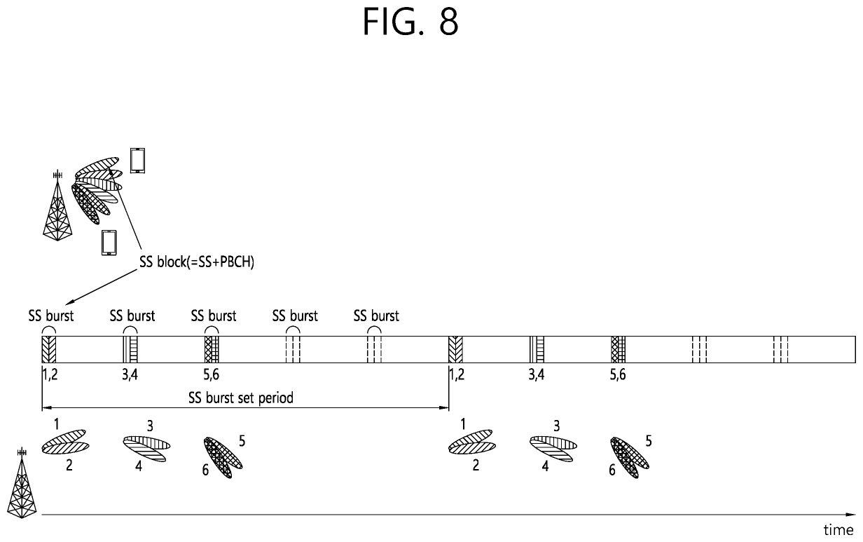

Meanwhile, in 5G NR, beam sweeping is performed for the SSB. This will be described with reference to FIG. 8.

FIG. 8 is an exemplary diagram illustrating an example of beam sweeping in NR.

The base station transmits each SSB in the SS burst while performing beam sweeping according to time. At this time, several SSBs in the SS burst set are transmitted to support terminals existing in different directions, respectively. In FIG. 6, an SS burst set includes SSBs 1 to 6, and each SS burst includes two SSBs.

### <Channel Raster and Sync Raster>

Hereinafter, a channel raster and a sync raster will be described.

A frequency channel raster is defined as a set of RF reference frequencies (FREF). The RF reference frequency may be used as a signal for indicating a location of an RF channel, SSB, or the like.

A global frequency raster is defined for all frequencies from 0 to 100 GHz. The unit of the global frequency raster is expressed as ΔF_{Global.}

The RF reference frequency is specified by an NR Absolute Radio Frequency Channel Number (NR-ARFCN) in the range (0 . . . 2016666) of the global frequency raster. The relationship between NR-ARFCN and the RF reference frequency (FREF) of MHz can be expressed by the following equation.

F_{REF}=F_{REF-Offs}+ΔF_{Global}(N_{REF}−N_{REF-Offs}) [Equation 1]

In Equation 1, F_{REF-offs} and N_{Ref-Offs} are shown in the following table.

TABLE 15

| Frequency | | | | |
|---|---|---|---|---|
| range | ΔF_{Global} | ΔF_{REF-Offs} | | |
| (MHz) | (kHz) | (MHz) | N_{REF-Offs} | Scope of N_{REF} |
| 0-3000 | 5 | 0 | 0 | 0-599999 |
| 3000-24250 | 15 | 3000 | 600000 | 600000-2016666 |
| 24250-100000 | 60 | 24250.08 | 2016667 | 2016667-3279165 |

The channel raster represents a subset of RF reference frequencies that can be used to identify RF channel positions in uplink and downlink. An RF reference frequency for an RF channel may be mapped to a resource element on a carrier wave.

The mapping between the RF reference frequency of the channel raster and the corresponding resource element can be used to identify the RF channel location. The mapping depends on the total number of RBs allocated to the channel and applies to both UL and DL.

If _{NR}B mod 2=0,

RE index k is 0,

The number of PRBs is as follows.

n_{PRB}=[N_{RB}/2]

If N_{RB} mod 2=1,

RE index k is 6,

The number of PRBs is as follows.

n_{PRB}=[N_{RB}/2]

The RF channel position of the channel raster on each NR operating band may be represented as shown in the table below.

TABLE 16

| NR | | Uplink frequency | Downlink frequency |
|---|---|---|---|
| operating | ΔF_{Raster} | range of Nref | range of Nref |
| band | (kHz) | (First-<Step size>-Last) | (First-<Step size>-Last) |
| n1 | 100 | 384000-<20>-396000 | 422000-<20>-434000 |
| n2 | 100 | 370000-<20>-382000 | 386000-<20>-398000 |
| n3 | 100 | 342000-<20>-357000 | 361000-<20>-376000 |
| n5 | 100 | 164800-<20>-169800 | 173800-<20>-178800 |
| n7 | 100 | 500000-<20>-514000 | 524000-<20>-538000 |
| n8 | 100 | 176000-<20>-183000 | 185000-<20>-192000 |
| n12 | 100 | 139800-<20>-143200 | 145800-<20>-149200 |
| n20 | 100 | 166400-<20>-172400 | 158200-<20>-164200 |
| n25 | 100 | 370000-<20>-383000 | 386000-<20>-399000 |
| n28 | 100 | 140600-<20>-149600 | 151600-<20>-160600 |
| n34 | 100 | 402000-<20>-405000 | 402000-<20>-405000 |
| n38 | 100 | 514000-<20>-524000 | 514000-<20>-524000 |
| n39 | 100 | 376000-<20>-384000 | 376000-<20>-384000 |
| n40 | 100 | 460000-<20>-480000 | 460000-<20>-480000 |
| n41 | 15 | 499200-<3>-537999 | 499200-<3>-537999 |
| | 30 | 499200-<6>-537996 | 499200-<6>-537996 |
| n51 | 100 | 285400-<20>-286400 | 285400-<20>-286400 |
| n66 | 100 | 342000-<20>-356000 | 422000-<20>-440000 |
| n70 | 100 | 339000-<20>-342000 | 399000-<20>-404000 |
| n71 | 100 | 132600-<20>-139600 | 123400-<20>-130400 |
| n75 | 100 | N/A | 286400-<20>-303400 |
| n76 | 100 | N/A | 285400-<20>-286400 |
| n77 | 15 | 620000-<1>-680000 | 620000-<1>-680000 |
| | 30 | 620000-<2>-680000 | 620000-<2>-680000 |
| n78 | 15 | 620000-<1>-653333 | 620000-<1>-653333 |
| | 30 | 620000-<2>-653332 | 620000-<2>-653332 |
| n79 | 15 | 693334-<1>-733333 | 693334-<1>-733333 |
| | 30 | 693334-<2>-733332 | 693334-<2>-733332 |
| n80 | 100 | 342000-<20>-357000 | N/A |
| n81 | 100 | 176000-<20>-183000 | N/A |
| n82 | 100 | 166400-<20>-172400 | N/A |
| n83 | 100 | 140600-<20>-149600 | N/A |
| n84 | 100 | 384000-<20>-396000 | N/A |
| n86 | 100 | 342000-<20>-356000 | N/A |

TABLE 17

| | | uplink downlink |
|---|---|---|
| | ΔF_{RASTER} | frequency range |
| NR operating band | (kHz) | (First-<Step size>-Last) |
| n257 | 60 | 2054166-<1>-2104165 |
| | 120 | 2054167-<2>-2104165 |
| n258 | 60 | 2016667-<1>-2070832 |
| | 120 | 2016667-<2>-2070831 |
| n260 | 60 | 2229166-<1>-2279165 |
| | 120 | 2229167-<2>-2279165 |
| n261 | 60 | 2070833-<1>-2084999 |
| | 120 | 2070833-<2>-2087497 |

On the other hand, the sync raster indicates the frequency position of the SSB used by the UE to obtain system information. The frequency location of the SSB can be defined as the SSREF using the corresponding GSCN number.

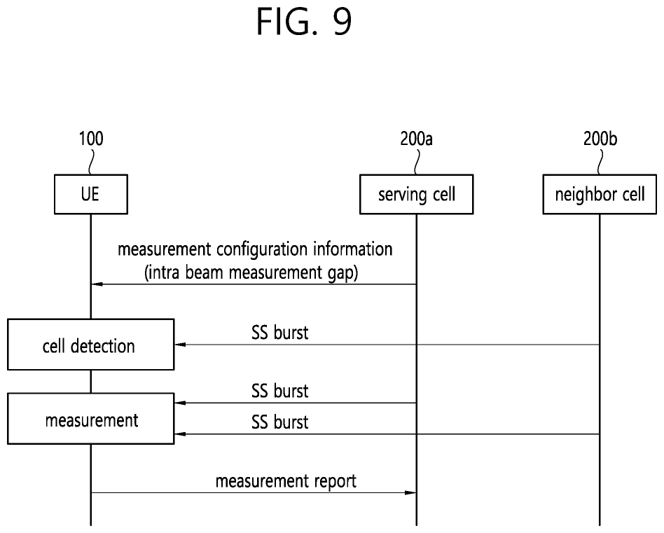

FIG. 9 shows a measurement and measurement reporting procedure considering an SS burst.

As can be seen with reference to FIG. 9, the terminal may receive measurement configuration information from the serving cell. The measurement setting information may include information on a first measurement gap, for example, an intra-beam measurement gap. In addition, the measurement configuration information may include information about a second measurement gap, for example, an intra RSRP measurement gap.

The UE may perform cell detection by receiving SS bursts from one or more neighboring cells.

In addition, the UE may perform measurement based on the SS burst received from one or more neighboring cells during the first measurement gap (eg, intra-beam measurement gap) indicated by the information. Also, the UE may perform measurement based on the SS burst received from the serving cell.

In addition, although not shown, the terminal may perform RSRP measurement based on the reference signal (RS) from the one or more neighboring cells during the second measurement gap.

And, the terminal may perform a measurement report.

### <Bandwidth Part: BWP>

In NR, broadband frequencies up to 400 MHz can be used. In order to allow various UEs to efficiently allocate and use frequency resources, NR introduces a new concept called BWP.

When the UEs perform initial access and transmit information about the capability of the UE to the base station, the base station sets the BWP to be used by the UE for each UE based on this information, and may transmit information on the BWP set to each UE. Then, downlink and uplink data transmission/reception between each UE and the base station is performed only through the BWP configured for each UE. That is, when the base station sets the BWP to the UE, the UE instructs not to use a frequency band other than the BWP when performing wireless communication with the base station thereafter.

The base station may set the entire band of the carrier frequency up to 400 MHz as the BWP for the UE, and may set only some bands as the BWP for the UE. In addition, the base station may configure multiple BWPs for one UE. When multiple BWPs are configured for one UE, the frequency bands of each BWP may or may not overlap each other.

### <L1-RSRP Measurement>

L1-RSRP measurement (layer 1 (physical layer) RSRP) is a measurement for the UE to perform reporting on the serving cell. For example, the UE may perform L1-RSRP measurement based on CSI-RS.

If configured by the Pcell or PSCell, the UE may measure SSB, CSI-RS or SSB and CSI-RS, and may perform L1-RSRP measurement of configured SSB, CSI-RS or SSB and CSI-RS resources. L1-RSRP measurement may be performed for resources configured for L1-RSRP measurement within the active BWP.

The UE may measure SSB resources of all CSI-RS resources or CSI resource sets within the CSI resource configuration configured for the active BWP. As long as the reporting quantity in the CSI-RS resource is not set to ‘none’, the UE may report the amount for the CSI reporting configuration related to the reporting quantity.

The UE may perform L1-RSRP measurement based on the CSI-RS resource configured for L1-RSRP calculation. And, the physical layer of the UE may measure L1-RSRP and report L1-RSRP based on a measurement period related to beam management using CSI-RS.

### <Radio Link Monitoring>

The UE monitors the downlink radio link quality of the primary cell in order to inform the higher layer of the out-of-sync/in-sync state. The UE monitors downlink quality in the active DL BWP on the primary cell, and there is no need to perform monitoring in other DL BWPs.

The UE may perform monitoring based on the RLM-RS. Here, it is a reference signal for RLM. The RLM-RS resource may be a resource included in a set of resources configured by higher layer signaling. The UE may be provided with information about the RLM-RS from the serving cell. For example, the information about the RLM-RS may be the RadioLinkMonitoringRS of Table 18.

TABLE 18

| | |
|---|---|
| RadioLinkMonitoringRS ::= | SEQUENCE { |
| radioLinkMonitoringRS-Id | RadioLinkMonitoringRS-Id, |
| purpose | ENUMERATED {beamFailure, rlf, both}, |
| detectionResource | CHOICE { |
| ssb-Index | SSB-Index, |
| csi-RS-Index | NZP-CSI-RS-ResourceId |
| } | |

In Table 18, radioLinkMonitoringRS-Id may be the ID of the RLM-RS. purpose indicates whether the UE will monitor the related RS for the purpose of cell and/or beam failure detection. detectionResource indicates the RS to be used by the UE for RLM or beam failure detection (according to purpose). ssb-Index is the index of the related SSB. csi-RS-Index is the ID of the NZP-CSI-RS resource. The UE may monitor the radio link quality based on the RS of the configured RLM-RS resource in order to detect the radio link quality of the Pcell and the PSCell. The configured RLM-RS resource may be all SSBs or all CSI-RSs or a combination of SSB and CSI-RS.

The UE may estimate the downlink radio quality in each RLM-RS resource to monitor the downlink radio link quality of the cell, and compare the estimated quality with threshold values Qᵢₙ and Qₒᵤₜ.

Here, Qₒᵤₜ may be defined as a level corresponding to an out-of-sync block error rate (BLERₒᵤₜ) in which a downlink radio link cannot be reliably received. In SSB-based RLM, Q_{out_SSB} may be used. Q_{out_SSB} may be derived based on virtual PDCCH transmission parameters associated with SSB-based RLM. In addition, Q_{out_CSI-RS} may be used in CSI-RS based RLM. Q_{out_CSI-RS} may be derived based on virtual PDCCH transmission parameters associated with CSI-RS based RLM.

Qᵢₙ can be received much more reliably than the downlink radio link quality in Qₒᵤₜ, and can be defined as a level corresponding to the in-sync block error rate (BLERᵢₙ). In SSB-based RLM, Q_{in_SSB} may be used. Q_{in_SSB} may be derived based on virtual PDCCH transmission parameters associated with SSB-based RLM. In addition, Q_{in_CSI-RS} may be used in CSI-RS based RLM. Q_{in_CSI-RS} may be derived based on virtual PDCCH transmission parameters associated with CSI-RS based RLM.

The physical layer of the UE informs the upper layer out-of-sync in the frames where the radio link quality is evaluated, if the radio link quality is worse than the threshold Qout for all resources in the set of resources for RLM. If the radio link quality is better than the threshold Qᵢₙ in any resource in the set of resources for RLM, the physical layer of the UE notifies the in-sync to the higher layer in the frame where the radio link quality is evaluated.

BLERᵢₙ and BLERₒᵤₜ may be determined based on network settings. For example, BLERᵢₙ and BLERₒᵤₜ may be determined by a parameter rlmInSyncOutOfSyncThreshold received through higher layer signaling. If the UE does not receive the network configuration related to BLERᵢₙ and BLERₒᵤₜ, BLERᵢₙ and BLERₒᵤₜ may be determined by default with configuration #0 in Table 19 below.

TABLE 19

| Configuration | BLERₒᵤₜ | BLERᵢₙ |
|---|---|---|
| 0 | 10% | 2% |

The UE may monitor maximum X_{RLM-RS} RLM-RS resources of the same type or different types corresponding to the carrier frequency band. Table 20 shows the X_{RLM-RS} corresponding to the carrier frequency band.

TABLE 20

| Maximum number of RLM-RS | |
|---|---|
| resources | Carrier frequency range |
| X_{RLM-RS} | of PCell/PSCell |
| 2 | FR1, ≤3 GHz |
| 4 | FR1, >3 GHz |
| 8 | FR2 |

When a different SCS is used for the CSI-RS-based RLM-RS and the SSB, the CSI-RS-based RLM-RS and the SSB must be time division multiplexed (TDM). When the same SCS is used for the CSI-RS-based RLM-RS and SSB, the CSI-RS-based RLM-RS and SSB must be FDM (Frequency Division Multiplexing) or TDM.

### <Quasi Co-Located (QCL)>

“Pseudo-co-located” means: Between two antenna ports, for example, if a large-scale property of a radio channel through which one symbol is transmitted through one antenna port is implied from a radio channel through which one symbol is transmitted through another antenna port. If it can be inferred, it can be expressed that the two antenna ports are pseudo-co-located.

Here, the wide range characteristic includes at least one of delay spread, Doppler spread, frequency shift, average received power, and received timing. Hereinafter, pseudo-co-located will be referred to simply as QCL.

That is, when the two antenna ports are QCLed, it means that the broadband characteristic of the radio channel from one antenna port is the same as the broadband characteristic of the radio channel from the other antenna port. Considering a plurality of antenna ports through which a reference signal (RS) is transmitted, if the antenna ports through which two different types of RS are transmitted are QCL, the wide range characteristics of the radio channel from one type of antenna port will be replaced to the wide range characteristics of the radio channel from other type of antenna port

According to the concept of QCL, for non-QCL antenna ports, the UE cannot assume the same broadband characteristic between radio channels from corresponding antenna ports. That is, in this case, the UE must perform independent processing for each configured non-QCL antenna port with respect to timing acquisition and tracking, frequency offset estimation and compensation, delay estimation and Doppler estimation, and the like.

For antenna ports that may assume QCL, the UE may perform the following operations:
For delay spread and Doppler spread, the UE calculates the power-delay-profile, delay spread and Doppler spread estimation results for a radio channel from any one antenna port, the same can be applied to a Wiener filter used when estimating a channel for a channel.
With respect to frequency shift and received timing, the UE may perform tracking time and frequency synchronization for one antenna port, and then apply the same synchronization to demodulation of another antenna port.
For average received power, the UE may average RSRP (Reference Signal

Received Power) measurements for two or more antenna ports.

In 5G NR, the UE has up to M TCI (Transmission Configuration Indicator)-states

(TCI-States) to decode the PDSCH by higher layer signaling according to the detected PDCCH along with the DCI for the UE and the serving cell. can be set. where M depends on the UE capability. Each configured TCI state may include one RS set TCI-RS-SetConfig. Each TCI-RS-SetConfig includes parameters for setting the QCL relationship between the RS in the RS set and the DM-RS port group of the PDSCH.

The RS set includes a reference for one or two DL RSs and a higher layer parameter QCL-Type for the associated QCL type (QCL-Type) for each DL RS. Regardless of whether the reference is to the same DL RS or to a different DL RS, for two DL RSs, the QCL type must not be the same.

The QCL types are known to the UE by a higher layer parameter QCL-Type, and the QCL type may be one or a combination of the following types:
QCL-TypeA: {Doppler shift, Doppler spread, mean delay, delay spread}
QCL-TypeB: {Doppler shift, Doppler diffusion}
QCL-TypeC: {Doppler shift, average delay}
QCL-TypeD: {spatial Rx parameter}

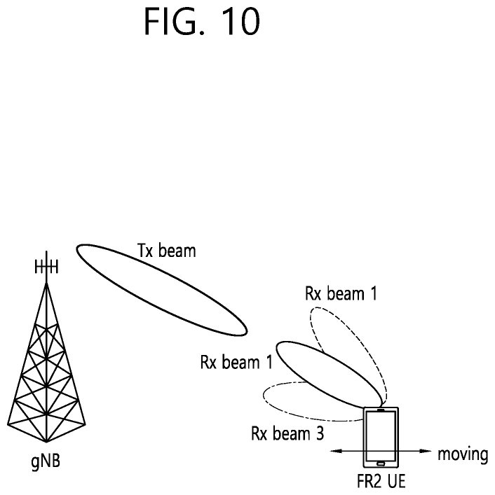

FIG. 10 is an exemplary diagram illustrating a situation in which an optimal reception beam is changed due to movement of a UE.

The UE operating in the FR 2 band performs radio link monitoring (RLM) using a plurality of reception beams. In the FR 2 band, since the maximum number of RLM-RS resources is 8, the UE can monitor up to 8 RLM-RSs.

If the mobility of the UE is not considered in the CONNECTED MODE, the UE may monitor the RLM using only one reception beam (Rx beam) paired with a next generation NodeB (gNB) transmission beam (Tx beam).

However, as shown in FIG. 10, Rx beams 1 to 3 may be changed according to the movement of the UE even if the paired Tx beams are the same. For example, if the reception beam paired with the transmission beam of the gNB is Rx beam 1, when the UE moves to the left, the optimal reception beam may be Rx beam 2, and when the UE moves to the right, the optimal reception beam is Rx It could also be beam 3.

On the other hand, the UE performs RLM measurement based on a measurement requirement (or RLM requirement) related to RLM, the number of reception beams and beam sweeping of the UE are not considered in the conventional measurement requirements. Therefore, according to the conventional measurement requirements, there is a problem that the UE cannot perform efficient RLM measurement.

Therefore, considering the mobility of the UE, the number of receive beams of the UE should be considered in the RLM requirement.

Measurement requirements related to RLM include an evaluation interval used to evaluate the quality of a downlink radio link (radio link). Here, the evaluation interval may include T_{Evaluate_in} and T_{Evaluate_out}. In SSB-based RLM, T_{Evaluate_in} and T_{Evaluate_out} may be expressed as T_{Evaluate_in_SSB} and T_{Evaluate_out_SSB}.

In SSB-based RLM, the UE estimates the quality of the downlink radio connection of the RLM-RS resource during T_{Evaluate_out}, and the UE may determine whether the quality of the estimated downlink radio connection is worse than the threshold value (Qout ssB) within the evaluation period T_{Evaluate_out}.

The UE estimates the quality of the downlink radio connection of the RLM-RS resource during T_{Evaluate_in}, and determines whether the quality of the estimated downlink radio connection is worse than the threshold value (Q_{out_SSB}) within the evaluation period T_{Evaluate_in}.

T_{Evaluate_in} and T_{Evaluate_out} in the FR 1 band may be defined, for example, as shown in Table 21 or Table 22. For reference, Tables 21 and 22 are only examples, and T_{Evaluate_in} and T_{Evaluate_out} may be defined as different values.

TABLE 21

| setting | T_{Evaluate}_{_{—}}ₒᵤₜ (ms) | T_{Evaluate}_{_{—}}ᵢₙ (ms) |
|---|---|---|
| In case DRX is | max(200, 10*T_{SSB}) | max(100, 5*T_{SSB}) |
| not set | | |
| DRX cycle ≤320 ms | max(200, [15]*max(T_{DRX}, T_{SSB})) | max(100, [8] *max(T_{DRX}, T_{SSB})) |
| DRX cycle >320 ms | max(200, [10]*max(T_{DRX}, T_{SSB})) | max(200, [5]*max(T_{DRX}, T_{SSB})) |

TABLE 22

| setting | T_{Evaluate}_{_{—}}ₒᵤₜ (ms) | T_{Evaluate}_{_{—}}ᵢₙ (ms) |
|---|---|---|
| In case DRX is | max(200, ceil(10*P)* T_{SSB}) | max(100, ceil(5*P)* T_{SSB}) |
| not set | | |
| DRX cycle ≤320 ms | max(200, ceil(15*P)*max(T_{DRX}, | max(100, ceil(7.5*P)*max(T_{DRX}, |
| | T_{SSB})) | T_{SSB})) |
| DRX cycle >320 ms | ceil(10*P)* T_{DRX} | ceil(5*P)* T_{DRX} |

DRX means discontinuous reception. The T_{SSB} may be a period of the SSB configured for RLM. T_{DRX} may be the length of the DRX cycle. ceil stands for the ceiling function, which is a rounding function.

P can be defined as follows.
When the measurement gap for intra-frequency measurement, the measurement gap for inter-frequency measurement, or the measurement gap for inter-RAT measurement partially overlaps with the SSB in the monitored cell (occasion of SSB) Some overlap with (occasion): P=1/(1−T_{SSB}/MGRP)
If the measurement gap does not overlap with the SSB in the monitored cell: P=1

In the FR 1 band, since the UE may not perform a beam sweeping operation, the number of receive beams does not need to be considered. However, in the FR 2 band, it is necessary to consider the number of receive beams as described above.

Considering the number of reception beams of the UE, T_{Evaluate_in} and T_{Evaluate_out} in the FR 2 band may be defined, for example, as shown in Table 23. For reference, Table 23 is only an example, and T_{Evaluate_in} and T_{Evaluate_out} may be defined as different values.

TABLE 23

| setting | T_{Evaluate}_{_{—}}ₒᵤₜ (ms) | T_{Evaluate}_{_{—}}ᵢₙ (ms) |
|---|---|---|
| In case DRX is | max(200, N*[10]*T_{SSB}) | max(100, N*[5]*T_{SSB}) |
| not set | | |
| DRX cycle ≤320 ms | max(200, | max(100, N*[8] *max(T_{DRX}, T_{SSB})) |
| | N*[15]*max(T_{DRX}, T_{SSB})) | |
| DRX cycle >320 ms | max(200, | max(200, N*[5]*max(T_{DRX}, T_{SSB})) |
| | N*[10]*max(T_{DRX}, T_{SSB})) | |

Table 23 is a first example of RLM measurement requirements considering the number of receive beams. Here, N means the number of receive beams.

Meanwhile, according to Table 23, depending on the N value and the period of the RLM-RS, the evaluation period may be too large to monitor the radio link quality. This is because, if the value of the evaluation interval is too large, the radio link quality monitoring result may become meaningless. Since the number N of receive beams is an implementation issue, it may have a different value for each UE, but may generally be 8. For example, when N (N=8) and the RLM-RS period are large, there is a disadvantage that the RLM requirement may become meaningless.

Therefore, in order to define an appropriate RLM measurement requirement, the value of N considers the number of receive beams, but may be defined as small numbers such as 2 and 3. That is, the RLM measurement requirement may be defined in consideration of the optimal number of beams M among the total number of received beams N. In order to select M optimal beams, a CSI-RS repetition mode for beam management may be used for RLM. To configure CSI-RS repetition for RLM, RLM-RS (SSB or CSI-RS resource) may be CSI-RS resource and QCL.

### <Problems to be Solved Through the Disclosure of This Specification>

5G uses a technology that utilizes a high-frequency band called millimeter wave (mmWave) as a mobile communication frequency. Because millimeter waves can transmit broadband, they are widely used in satellite communication, mobile communication, radio navigation, earth exploration, and radio astronomy. Because millimeter wave has a short radio wave wavelength, it has a low radio wave transmission power, so it has a short reach and is easily affected by obstacles, making it difficult to use in mobile communication services. In order to utilize a mobile communication service, a radio wave may be directly transmitted to the terminal by using a narrow beam.

On the other hand, terminal devices (smartphones, automobiles, robots, base stations, etc.) supporting these millimeter waves use directional transmission/reception beams to overcome signal attenuation due to high frequency characteristics. In order to transmit and receive a signal through the directional transmit/receive beam, the directional beam of the transmitting terminal and the directional beam of the receiving terminal must coincide with each other.

However, when a narrow beam is used, it becomes more difficult to maintain an optimized transmission/reception beam. As a result, interference generated in an adjacent channel increases. In addition, when a strong interference signal enters an adjacent channel, a signal of a low power level may not be received due to in-channel selectivity (ICS) and adjacent channel interference. This causes deterioration of the reception performance of the reception terminal, and there is a problem in that the reception terminal cannot receive a signal when the adjacent channel interference power is greater than the reception power by a certain amount.

### <Disclosure of the Present Specification>

The disclosures herein may be implemented in a combination of one or more of the following methods/operations/configurations/steps. In addition, the disclosures and proposals described below are classified into a table of contents for convenience of description. Each disclosure and proposal may be implemented independently or in combination with other disclosures and proposals.

### I. First Disclosure

In this specification, a method for allocating transmission/reception resources in consideration of adjacent channel interference and in-channel selectivity (ICS) will be described. In the present specification, description is based on vehicle to everything (V2X), which is vehicle-to-vehicle communication based on sidelink, but may be applied to other terminals or other types of link connections.

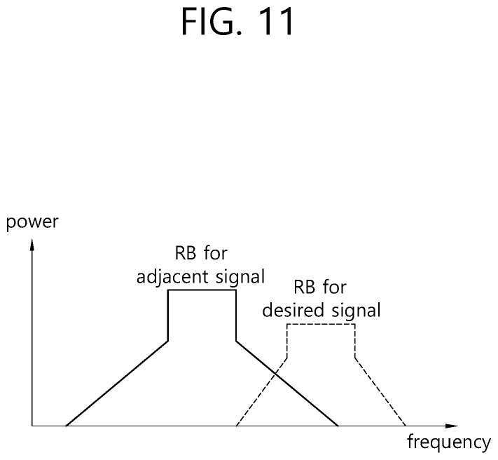

FIG. 11 is an exemplary diagram illustrating adjacent channel interference.

Adjacent channel interference is generated by signals at adjacent frequencies or signals in adjacent resource blocks (RBs) within the same frequency. In the present specification, the description is based on an interference signal in an adjacent RB within the same frequency, but may be extended and applied to an interference signal in an adjacent frequency. Adjacent channel interference affects a received signal due to signal leakage of an adjacent channel. Basically, the greater the signal strength of the adjacent channel and the smaller the allocated resource interval, the greater the interference effect on the received signal. In millimeter wave (mmWave), a transmission/reception beam is formed in an allocated resource, so that an interference signal in an adjacent channel may be reduced. However, if the transmission/reception beam is not perfect, interference in an adjacent channel may become larger. In addition, since a narrow beam and a wide beam are flexibly used in millimeter wave according to the surrounding environment, even when a wide beam is used, the interference effect in an adjacent channel increases.

In ICS, when a signal having a high reception level exists within a reception bandwidth of interference, a relatively weak signal is expressed below the interference level from the standpoint of the baseband, making reception impossible. In this case, interference occurs regardless of the frequency separation distance of each reception signal within the reception bandwidth.

A case in which interference occurs between terminals communicating in a one-to-one manner (multiple unicast) and a case in which interference occurs in a situation in which communication occurs in a one-to-many manner (multi-cast) are divided and will be described later.

### 1. Multiple Unicast Environment

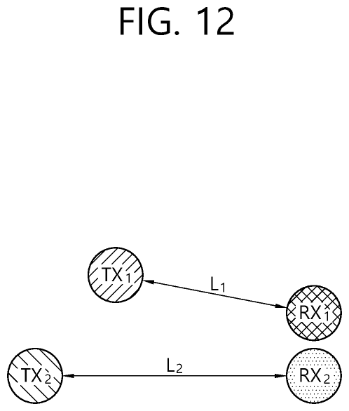

FIG. 12 illustrates an example in which interference appears.

A signal that the terminal Tx1 sends to the terminal Rx1 may interfere with communication between the terminal Tx2 and the terminal Rx2. Such an environment may be an example of multiple unicast. When there is another unicast (or multi-case, broadcast) terminal in the vicinity of the terminal Rx2, resource allocation (Resource pool, RB allocation, . . . ) between terminals (Tx2−Rx2) may be affected by the resource allocation state between Tx1−Rx1. That is, due to the received signal level coming into the terminal Rx2 from the resources allocated to the terminal Tx1 and the terminal Rx1 (ex. resource pool, RB allocation, . . . ) and the adjacent channel interference, the link quality in the resources allocated to the terminal Tx2 and the terminal Rx (Link quality) (L2) only may affect the reception performance of the UE Rx2. A method for avoiding such interference will be described later by dividing ICS and adjacent channel interference.

### 1) ICS Avoidance

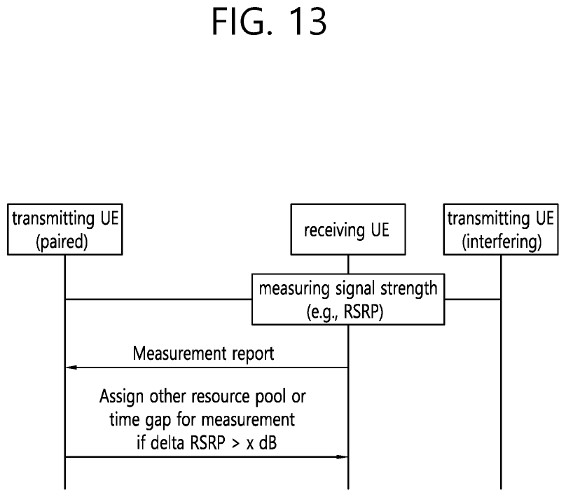

FIG. 13 is a flowchart illustrating an operation according to a first example of the first disclosure of the present specification.

The receiving terminal Rx2 may measure the signal strength from the terminal Tx1 and the terminal Tx2 for a candidate resource (ex. resource pool, sub-band, RBs, etc). The signal strength may correspond to RSRP (Reference Signal Receive Power). In order to measure the signal strength, the terminal Rx2 may measure the signal strength for the allocated resource using a control signal or a synchronization signal transmitted from the terminal Tx1. In this case, the signal strength from the terminal Tx1 and the terminal Tx2 may be measured in a state where the beam of the terminal Rx2 is formed by the transmitting terminal Tx2. And when different beams are operated for each terminal direction, the terminal Rx2 may use corrected value in consideration of the gain of its own reception beam.

The terminal Rx2 may transmit information about the measured signal strength to the terminal TX2.

Then, the terminal Tx2 may calculate whether the difference in signal strength between the signal of the terminal Tx1 and the signal of the terminal Tx2 exceeds a predetermined value x(dB) or more based on the received signal strength. If there is a possibility that the ICS effect occurs by exceeding a certain value, the terminal Tx2 operates a resource pool having a time resource different from that of the terminal Tx1, or a resource pool having a different reception channel band (ex. bandwidth) part) to avoid the ICS impact.

By using the changed resource pool, the terminal Tx2 may communicate with the terminal Rx2.

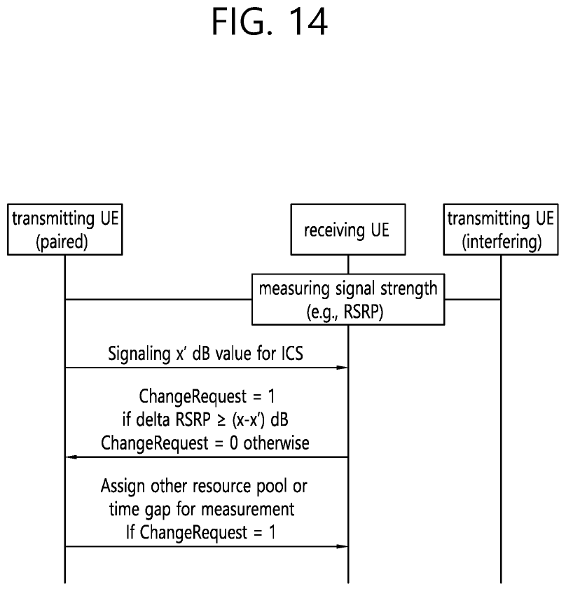

FIG. 14 is a flowchart illustrating an operation according to a second example of the first disclosure of the present specification.

The terminal Rx2 may measure the signal strength from the terminal Tx1 and the terminal Tx2.

The terminal Tx2 may transmit to the terminal Rx2 a constant value x′ (dB) according to parameters (eg, modulation order, number of layers, packet QoS, subcarrier spacing, . . . ) in consideration of the signal to be transmitted. The terminal Rx2 may have an x(dB) value set. The x(dB) value is a receivable power imbalance value of the terminal with respect to ICS and may be set differently for each terminal.

The terminal Rx2 may calculate whether the difference between the RSRP value of the signal of the terminal Tx1 and the RSRP value of the signal of the terminal Tx2 is greater than or equal to x−x′ (dB). When the difference between the RSRP value of the signal of the terminal Tx1 and the RSRP value of the signal of the terminal Tx2 is x−x′ (dB) or more, the terminal Rx2 assigns the resource to another resource (ex. resource pool, time gap, . . . ) to the terminal Tx2. A request signal (1-bit ChangeRequest) may be transmitted. Then, the terminal Tx2 may change and allocate resources to be used for communication with the terminal Rx2. Furthermore, the terminal Tx2 may communicate with the terminal Rx2 using the resource.

On the other hand, when the difference between the RSRP value of the signal of the terminal Tx1 and the RSRP value of the signal of the terminal Tx2 is not more than x−x′ (dB), the terminal Rx2 transmits a signal (Obit ChangeRequest) to the terminal Tx2, then the resources currently used for communication may be used without any changes.

Since the values of x and x′ are determined according to the terminal and the surrounding environment, whether to change the resource may be determined in consideration of the transmitter, the receiver, and the surrounding environment. When considering other resources, if a multiple resource pool such as a frequency band part (BWP) is not configured, a time gap is randomly selected within a certain interval or y slot to perform the above-described operations. Then the aforementioned operations may be operated in the selected time gap.

### 2) Avoid Adjacent Channel Interference

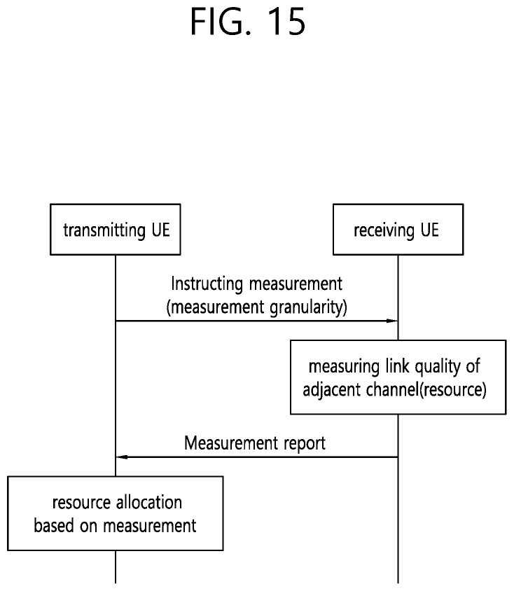

FIG. 15 is a flowchart illustrating an operation according to a third example of the first disclosure of the present specification.

With respect to the resource changed by the aforementioned ICS avoidance, the transmitting terminal Tx2 may give a measurement granularity to the receiving terminal Rx2 to indicate adjacent channel measurement in allocable resources. The receiving terminal Rx2 may measure Received Signal Strength Indication (RSSI) based on a predetermined unit (measurement granularity) descended from the transmitting terminal. Alternatively, when there is no measurement granularity, Received Signal Strength Indication (RSSI) may be measured in a predetermined RB unit (sub-band) unit for allocable resources. Alternatively, the size (RSRP, SNR, ...) of a signal transmitted from the adjacent terminal Tx1 for allocable resources according to the UE capability may be measured. In this case, the beam of the UE Rx2 to be measured may maintain a state formed by the transmitting terminal Tx2. The receiving terminal Rx2 may report the measured RSSI to the terminal Tx2. The UE Rx2 may report the RSSI of all sub-bands, the RSSI difference between sub-bands, and specific sub-bands having a large RSSI difference to the UE Tx2. Based on the reported information and the parameters (ex. modulation order, number of layers, packet QoS, subcarrier spacing, . . . ) in consideration of the signal to be transmitted by the terminal Tx2, the terminal Tx2 may inform the terminal Rx2 about the resource for transmitting the signal to the terminal Rx2. When the modulation order is high, in order to minimize interference of adjacent channels, a resource (high resource frequency gap) as far away as possible from the resources allocated to the terminal Tx1 and the terminal Rx1 may be selected. That is, the frequency separation distance of the allocated resources may be.

resource frequency gap∝1/ΔRSSI

the frequency separation distance of the allocated resources may be set based on the above relation. The same may be applied to the case of measuring other link quality such as RSRP or SNR, and in the case of measuring RSRP, the RSRP used for ICS avoidance may be reused.

### 2. Multi-Cast Environment

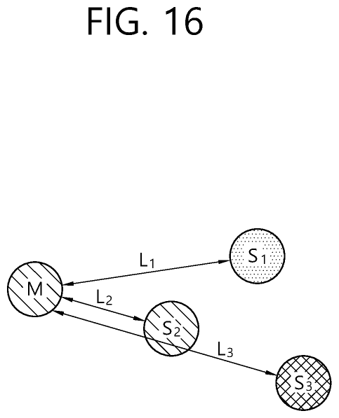

FIG. 16 illustrates an example in which interference appears.

The terminal M and the terminals S1, S2, and S3 may perform one-to-many multi-cast communication. The terminal M may transmit a signal to the terminals S1, S2, and S3, and the terminals S1, S2, and S3 may transmit a signal to the terminal M. From the terminal M, the terminal S2 and the terminal S3 may be located in the same direction. In this case, when the terminal M receives the signals of the terminal S2 and the terminal S3 with one beam, the two signals may cause adjacent channel interference with each other. Also, when the signal strength difference between the two signals is large (ICS), reception performance may be affected. A method for avoiding such interference will be described later by dividing ICS and adjacent channel interference.

### 1) ICS Avoidance

In the case of multicast, the terminal M may control the resources of the terminals S1, S2, and S3. Terminals S1, S2, S3 report the measured RSRP to terminal M, or terminal M measures RSRP based on a specific signal from UE S1, S2, S3 to set a resource group between terminals with similar RSRP levels. For example, S-terminals having similar RSRP levels (delta RSRP<y dB) may be set as one group. The ICS influence may be avoided by allocating the group set in this way as one resource pool (ex. BWP) or the same time gap. Resource grouping may reduce terminal complexity and power consumption by reducing bit resolution of an analog to digital converter (ADC).

### 2) Avoid Adjacent Channel Interference

When the terminals S2 and S3 are allocated to the same resource pool, the terminal M may measure link quality as a measurement operation for avoiding adjacent channel interference. The terminal M may allocate resources for minimizing the adjacent channel interference between the terminals S2-S3 to the terminals S2 and S3 based on RSRP information of the signals from the terminals S2 and S3. Resources may be allocated based on link quality for adjacent channels measured by terminals S2 and S3. As a result of measuring the connection quality (ex. RSRP, RSSI) between the terminals M-S2 and M-S3, if the difference in RSRP is large, resources may be allocated in a way that sets a large resource frequency gap. In addition, it is possible to allocate resources by adjusting the resource frequency gap according to the RSRP difference as well as the parameters.

### II. Second Disclosure

Terminal devices (smartphones, automobiles, robots, base stations, etc.) supporting millimeter wave use a directional transmit/receive beam to overcome signal attenuation due to high frequency characteristics. In order to transmit/receive a signal through the directional transmit/receive beam, the directional beams between the transmitting terminal and the receiving terminal must match. To this end, a process of selecting a beam optimized for signal transmission and reception by measuring the signal strength of all directional beams formed by the terminal is required. A method of selecting such a transmission/reception beam and a terminal transmission/reception operation necessary for this may be referred to as beam management (beam management.BM). This will be explained.

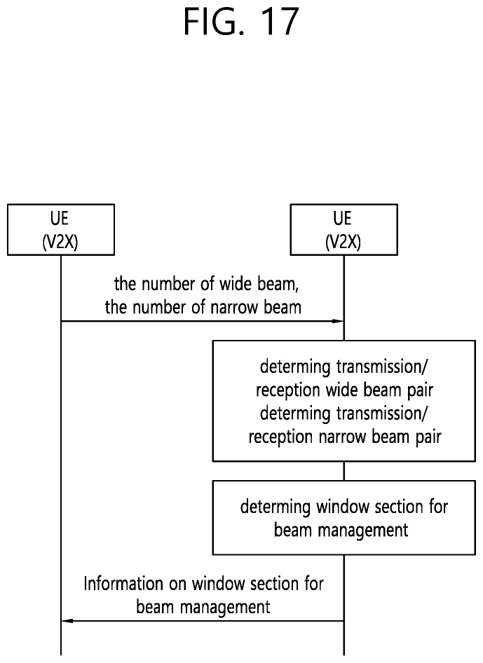

FIG. 17 is a flowchart illustrating an operation according to one start of beam management according to the first example of the second disclosure.

The receiving terminal may transmit information about the number of wide beams and narrow beams to be operated to the transmitting terminal through the sidelink. The transmitting terminal may select a transmission/reception wide beam pair based on a wide beam based on the information. A narrow beam pair may be selected based on a narrow beam within the selected wide beam. In this way, the overall beam pair selection time may be reduced. In addition, based on the number of wide beams/narrow beams of the receiving terminal, the transmitting terminal may determine a wide/narrow beam management window duration required for beam pair selection. This method may efficiently manage the beam management time. The transmitting terminal may transmit information about the configured beam management window period to the receiving terminal.

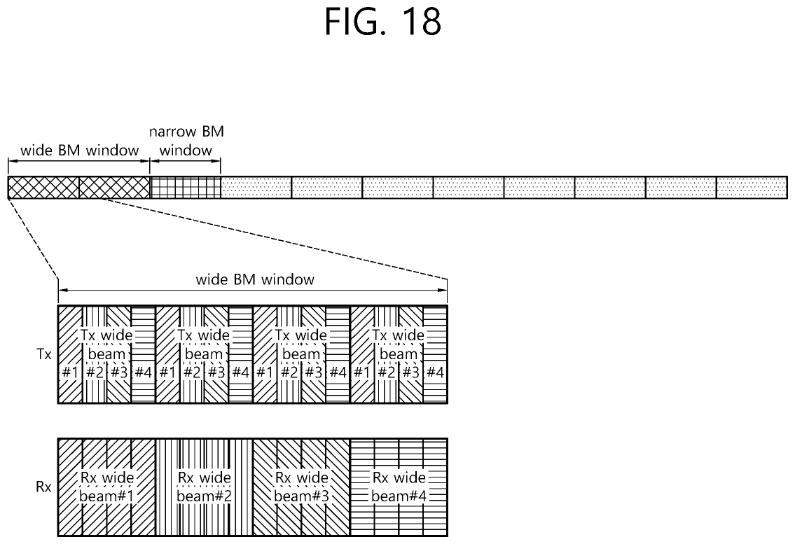

FIG. 18 is an exemplary diagram illustrating an example of beam management.

When the number of wide beams of the receiving terminal is 4 and the number of wide beams of the transmitting terminal is 4, beam sweeping may be required at No. 16. Assuming that a reference signal (RS) for one beam is transmitted as one symbol, a wide beam management window duration of 16 symbols may be set. The beam management window duration (BM window duration) may be flexibly set according to the number of beams to be operated, or may be set to a predetermined window duration. For example, a window period for beam management may be designated as (1, 2, 3, 4, 5 msec), and one of them may be notified to the receiving terminal to perform beam management. The transmitting terminal may set a period for beam management, notify the receiving terminal, and transmit information indicating that beam management may be performed in the corresponding period.

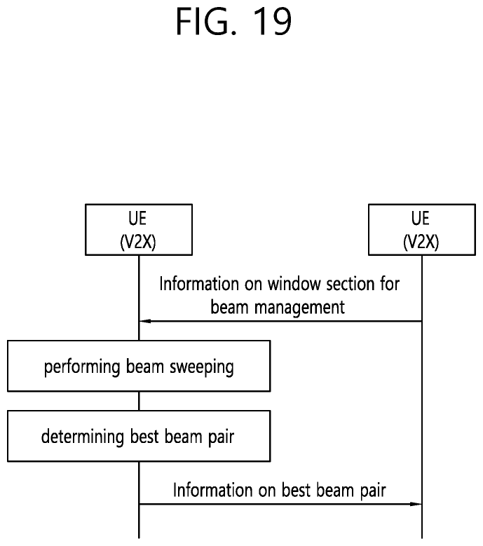

FIG. 19 is a flowchart illustrating an exemplary operation of beam management according to a second example of the second disclosure.

As described above in FIG. 17, information on the beam management window section set by the transmitting terminal may be transmitted to the receiving terminal. The receiving terminal may determine a best beam pair by performing beam sweeping during the configured beam management window period. The receiving terminal may report information about the selected best beam pair to the transmitting terminal. At this time, the wide beam BM (beam management) report may be reported using the sidelink at a frequency of 6 GHz or less because it is before the beam pair is set, and the narrow beam BM report may be reported using wide beam or using sidelink at a frequency of 6 GHz or less because it is after the wide beam pair is selected.

The timing at which the terminal performs the beam management may be performed every set period or may be performed aperiodically.

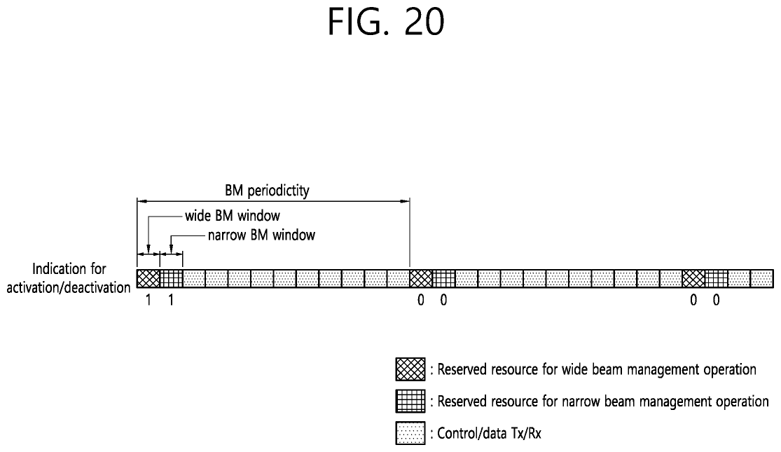

FIG. 20 is an exemplary diagram illustrating an example of periodic beam management.

A period for performing beam management in the transmission/reception terminal may be set. The transceiver terminal may perform beam management on a wide/narrow beam management window every set beam management period. As a result of the execution, the beam pair may be reconfigured or maintained.

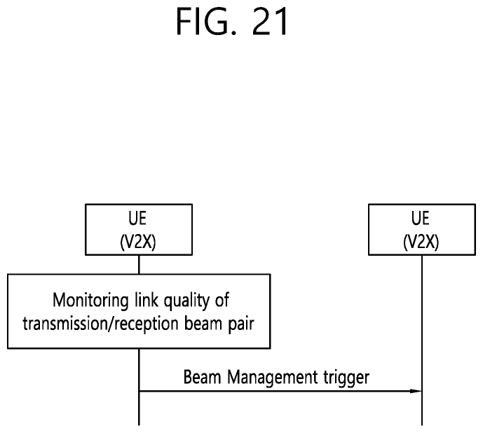

FIG. 21 is an exemplary diagram illustrating an example of aperiodic beam management.

The receiving terminal may transmit an indication or a trigger for beam management activation/deactivation to the transmitting terminal for the wide/narrow beam management window. For wide/narrow BM, when an indication is set to ‘1’ in a specific resource (reserved resource), wide/narrow beam management may be performed on the resource. when an indication is set to ‘0’ in a specific resource (reserved resource), the resource may be used for control or data transmission.

The receiving terminal may measure a connection quality reference signal (eg, CSI-RS) of a beam pair used for control/data transmission. When a state in which the measured value is equal to or less than a specific value (ex.Qout) is maintained for a certain period of time, the receiving terminal may transmit a beam management trigger to the transmitting terminal through the sidelink. Upon receiving the beam management trigger, the transmitting terminal may set an indication to ‘1’ in a reserved resource for beam management closest to the received time. Whether to perform beam management of the wide beam and the narrow beam may be determined based on a set connection quality reference signal (eg, CSI-RS) for the narrow beam.

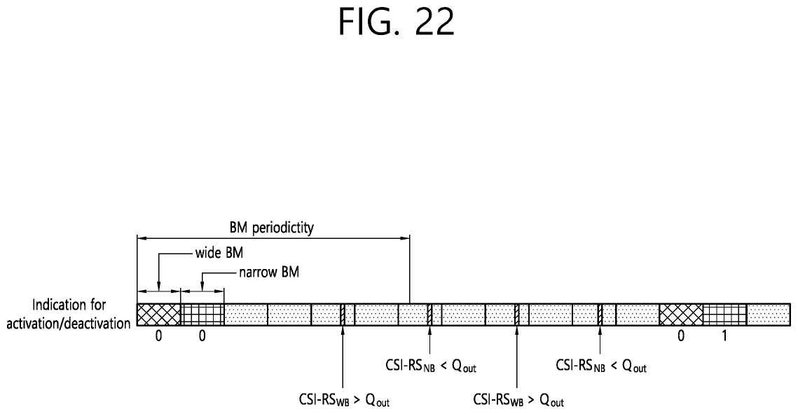

FIG. 22 is an exemplary diagram illustrating another example of aperiodic beam management.

If the CSI-RS for the wide beam is less than the specific value (Qout) and the CSI-RS for the narrow beam is less than the specific value (Qout), the indication for the wide beam may be ‘1’ and the indication for the narrow beam may be ‘1’. If the CSI-RS for the wide beam is greater than the specific value (Qout) and the CSI-RS for the narrow beam is less than the specific value (Qout), the indication for the wide beam may be ‘0 ’ and the indication for the narrow beam may be ‘1’. If the CSI-RS for the wide beam is greater than the specific value (Qout) and the CSI-RS for the narrow beam is greater than the specific value (Qout), the indication for the wide beam may be ‘0’ and the indication for the narrow beam may be ‘0’. If the CSI-RS for the wide beam is less than the specific value (Qout) and the CSI-RS for the narrow beam is greater than the specific value (Qout), the indication for the wide beam may be ‘0’ and the indication for the narrow beam may be ‘0’.

In the case of inter-vehicle sidelink communication, the selected beam pair may be changed according to the direction of the vehicle. When the transmitting vehicle changes the direction, since the transmitting beam deviates from the receiving vehicle's beam, beam management must be performed. This is a specific resource for BM by recognizing the situation in which the steering wheel direction of the vehicle is changed (interlocking with the CAM message) and determining whether to perform wide/narrow beam BM or narrow beam BM according to the steering wheel direction change angle. The indication may be set to ‘1’. For example, whether the wide/narrow BM indication is set to ‘1’ or only the narrow BM indication is set to ‘1’ may be determined, considering the handle direction and wide/narrow beam width. When the HARQ feedback of the receiving terminal with respect to the data from the transmitting terminal is not performed for more than a predetermined time (ex. Tout), the transmitting terminal may determine that the quality of the current beam-paired link is poor. Therefore, the indication of a specific resource (reserved resource) for beam management may be set to ‘1’ and transmitted to the receiving terminal through the sidelink to perform beam management.

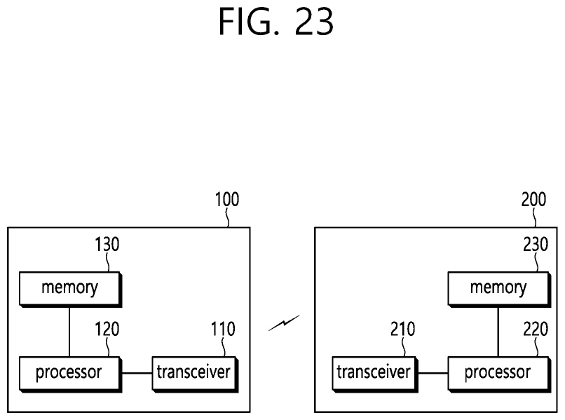

FIG. 23 is a block diagram illustrating a UE and a base station in which the disclosure of the present specification is implemented.

Referring to FIG. 23, a UE 100 and a base station 200 (eg, a serving cell) may implement the disclosure of the present specification. The UE 100 may be a UE described in the disclosure of this specification. And, the base station 200 may be the AMF, PCF, etc. described in the disclosure of the present specification.

The illustrated UE 100 includes a processor 120, a memory 130, and a transceiver 110. The illustrated base station 200 likewise includes a processor 220, a memory 230 and a transceiver 210. The illustrated processors 120 and 220, the memories 130 and 230, and the transceivers 110 and 210 may each be implemented as separate chips, or at least two or more blocks/functions may be implemented through a single chip.

The transceivers 110 and 210 include a transmitter and a receiver. When a specific operation is performed, only one operation of the transmitter and the receiver may be performed, or both the operation of the transmitter and the receiver may be performed. The transceivers 110 and 210 may include one or more antennas for transmitting and/or receiving radio signals. In addition, the transceivers 110 and 210 may include an amplifier for amplifying a reception signal and/or a transmission signal and a bandpass filter for transmission in a specific frequency band.

The processors 120 and 220 may implement the functions, processes and/or methods proposed in this specification. The processors 120 and 220 may include an encoder and a decoder. For example, the processors 120 and 230 may perform an operation according to the above description. The processors 120 and 220 may include application-specific integrated circuits (ASICs), other chipsets, logic circuits, data processing devices, and/or converters for converting baseband signals and radio signals to each other.

The memories 130 and 230 may include read-only memory (ROM), random access memory (RAM), flash memory, memory cards, storage media, and/or other storage devices.

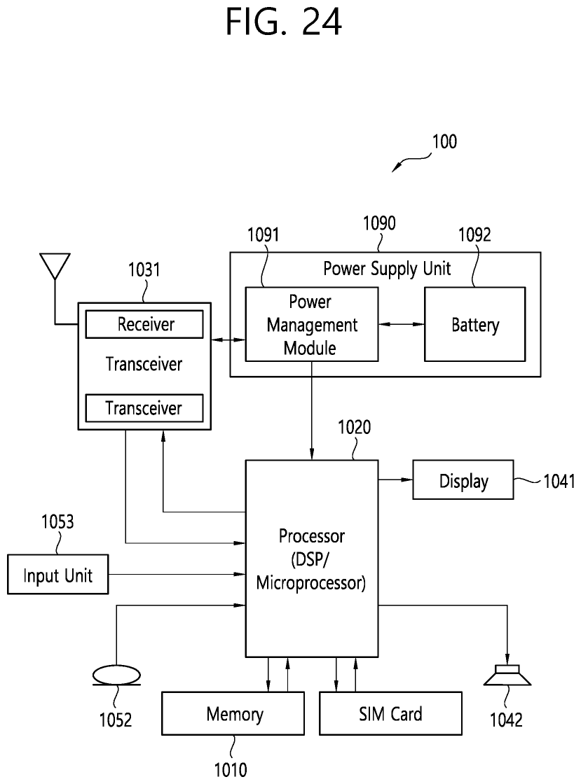

FIG. 24 is a block diagram illustrating a configuration of a UE according to an embodiment.

In particular, FIG. 24 is a diagram illustrating the UE device of FIG. 23 in more detail above.

The device includes a memory 1010, a processor 1020, a transceiver 1031, a power management module 1091, a battery 1092, a display 1041, an input unit 1053, a speaker 1042 and a microphone 1052; A subscriber identification module (SIM) card, containing one or more antennas.

The processor 1020 may be configured to implement the proposed functions, procedures, and/or methods described herein. The layers of the air interface protocol may be implemented in the processor 1020. The processor 1020 may include an application-specific integrated circuit (ASIC), other chipsets, logic circuits, and/or data processing devices. The processor 1020 may be an application processor (AP). The processor 1020 may include at least one of a digital signal processor (DSP), a central processing unit (CPU), a graphics processing unit (GPU), and a modem (modulator and demodulator). Examples of processor 1020 include SNAPDRAGONTM series processors manufactured by Qualcomm®, EXYNOS™ series processors manufactured by Samsung®, A series processors manufactured by Apple®, HELIO™ series processors manufactured by MediaTek®, INTEL® It may be an ATOm™ series processor manufactured by the company or a corresponding next-generation processor.

The power management module 1091 manages power for the processor 1020 and/or the transceiver 1031. The battery 1092 supplies power to the power management module 1091. The display 1041 outputs the result processed by the processor 1020. Input 1053 receives input to be used by processor 1020. The input unit 1053 may be displayed on the display 1041. A SIM card is an integrated circuit used to securely store an international mobile subscriber identity (IMSI) and its associated keys used to identify and authenticate subscribers in mobile phone devices such as mobile phones and computers. Many SIM cards can also store contact information.

The memory 1010 is operatively coupled to the processor 1020, and stores various information for operating the processor 610. Memory 1010 may include read-only memory (ROM), random access memory (RAM), flash memory, memory cards, storage media, and/or other storage devices. When the embodiment is implemented in software, the techniques described in this specification may be implemented in modules (eg, procedures, functions, etc.) that perform the functions described in this specification. Modules may be stored in memory 1010 and executed by processor 1020. The memory 1010 may be implemented inside the processor 1020. Alternatively, the memory 1010 may be implemented outside the processor 1020, and may be communicatively connected to the processor 1020 through various means known in the art.

The transceiver 1031 is operatively coupled to the processor 1020 and transmits and/or receives a wireless signal. The transceiver 1031 includes a transmitter and a receiver. The transceiver 1031 may include a baseband circuit for processing a radio frequency signal. The transceiver controls one or more antennas to transmit and/or receive radio signals. The processor 1020 transmits command information to the transceiver 1031 to transmit, for example, a wireless signal constituting voice communication data to initiate communication. The antenna functions to transmit and receive radio signals. When receiving a wireless signal, the transceiver 1031 may transmit the signal for processing by the processor 1020 and convert the signal to a baseband. The processed signal may be converted into audible or readable information output through the speaker 1042.

The speaker 1042 outputs sound related results processed by the processor 1020.

Microphone 1052 receives sound related input to be used by processor 1020.

The user inputs command information such as a phone number by, for example, pressing (or touching) a button of the input unit 1053 or voice activation using the microphone 1052. The processor 1020 receives such command information and processes it to perform an appropriate function, such as making a call to a phone number. Operational data may be extracted from the SIM card or the memory 1010. In addition, the processor 1020 may display command information or driving information on the display 1041 for the user to recognize and for convenience.

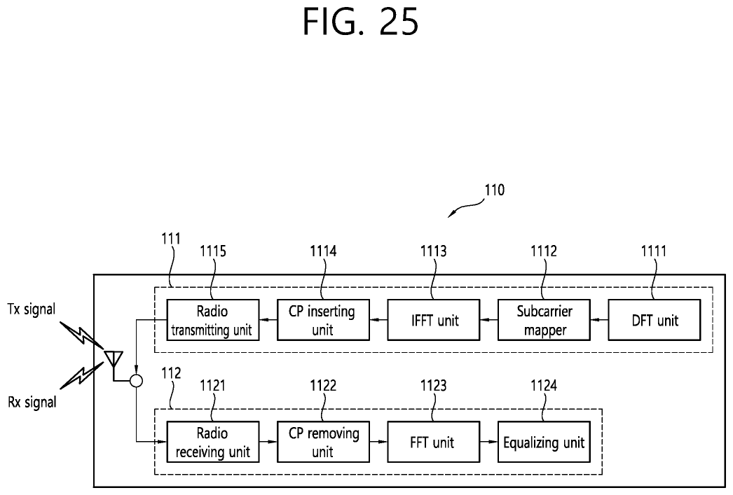

FIG. 25 is a detailed block diagram of a transceiver of a UE or a base station shown in FIG. 23.

In FIG. 25, the transceiver 110 means a transceiver of a UE (110 in FIG. 23) or a transceiver of a base station (210 in FIG. 23). Referring to FIG. 15, the transceiver 110 includes a transmitter 111 and a receiver 112. The transmitter 111 includes a Discrete Fourier Transform (DFT) unit 1111, a subcarrier mapper 1112, an IFFT unit 1113, a CP insertion unit 11144, and a wireless transmitter 1115. The transmitter 111 may further include a modulator. In addition, for example, a scramble unit (not shown; scramble unit), a modulation mapper (not shown; modulation mapper), a layer mapper (not shown; layer mapper) and a layer permutator (not shown; layer permutator) may be further included, This may be disposed prior to the DFT unit 1111. That is, in order to prevent an increase in the peak-to-average power ratio (PAPR), the transmitter 111 first passes information through the DFT 1111 before mapping a signal to a subcarrier. The signal spread (or precoded in the same sense) by the DFT unit 1111 is subcarrier mapped through the subcarrier mapper 1112 and then passed through the Inverse Fast Fourier Transform (IFFT) unit 1113 on the time axis. make it a signal.

The DFT unit 1111 outputs complex-valued symbols by performing DFT on input symbols. For example, when Ntxsymbols are input (however, Ntx is a natural number), the DFT size is Ntx. The DFT unit 1111 may be called a transform precoder. The subcarrier mapper 1112 maps the complexsymbols to each subcarrier in the frequency domain. The complexsymbols may be mapped to resource elements corresponding to resource blocks allocated for data transmission. The subcarrier mapper 1112 may be called a resource element mapper. The IFFT unit 1113 outputs a baseband signal for data that is a time domain signal by performing IFFT on an input symbol. The CP insertion unit 1114 copies a part of the rear part of the base band signal for data and inserts it into the front part of the base band signal for data. Inter-symbol interference (ISI) and inter-carrier interference (ICI) are prevented through CP insertion, so that orthogonality can be maintained even in a multi-path channel.

On the other hand, the receiver 112 includes a radio receiver 1121, a CP remover 1122, an FFT unit 1123, and an equalizer 1124. The wireless receiving unit 1121, the CP removing unit 1122, and the FFT unit 1123 of the receiver 112 perform the inverse function of the wireless transmitting unit 1115, the CP inserting unit 1114, and the IFF unit 1113 in the transmitting end 111. The receiver 112 may further include a demodulator.

The processor may include an application-specific integrated circuit (ASIC), other chipsets, logic circuits, and/or data processing devices. Memory may include read-only memory (ROM), random access memory (RAM), flash memory, memory cards, storage media, and/or other storage devices. The RF unit may include a baseband circuit for processing a radio signal. When the embodiment is implemented in software, the above-described technique may be implemented as a module (process, function, etc.) that performs the above-described function. A module may be stored in a memory and executed by a processor. The memory may be internal or external to the processor, and may be coupled to the processor by various well-known means.

In the exemplary system described above, the methods are described on the basis of a flowchart as a series of steps or blocks, but the present disclosure is not limited to the order of steps, and some steps may occur in a different order or concurrently with other steps as described above. In addition, those skilled in the art will understand that the steps shown in the flowchart are not exhaustive and that other steps may be included or that one or more steps in the flowchart may be deleted without affecting the scope of the present disclosure.

1. A method for communicating with a first receiving UE (user equipment), performed by a first transmitting UE, comprising:
receiving, by the first transmitting UE, a measurement report from the first receiving UE,
wherein the measurement report includes result of the first receiving UE measuring a first signal strength from the first transmitting UE and a second signal strength from a second transmitting UE;
determining whether to change a resource for allocation to be used for communication with the first receiving UE, based on a difference between the first signal strength and the second signal strength;
performing communication by allocating resource for communication with the first receiving UE.

2. The method of claim 1,
wherein the step of determining whether to change a resource for allocation to be used for communication with the first receiving UE is determining to change a resource for allocation only when the difference between the first signal strength and the second signal strength is greater than or equal to a specific value.

3. The method of claim 1,
wherein the first signal strength and the second signal strength are measured based on RSRP (Reference Signal Receive Power).

4. The method of claim 1, further comprising:
transmitting instruction to measure the first signal strength and the second signal strength to the first receiving UE.

5. The method of claim 1, further comprising:
transmitting information on the number of wide beams and the number of narrow beams to the first receiving UE;
receiving information on a window section for beam management from the first receiving UE;
wherein the step of performing communication by allocating resource for communication with the first receiving UE comprises performing beam sweeping to determine an optimal beam pair.

6. The method of claim 1, further comprising:
receiving beam management trigger from the first receiving UE, wherein the step of performing communication by allocating resource for communication with the first receiving UE comprises allocating, by the first transmitting UE, resource by performing beam management.

7. A method for communicating with a first transmitting UE (user equipment), performed by a first receiving UE, comprising:
receiving a first specific value from the first transmitting UE;
measuring a first signal strength from the first transmitting UE;
measuring a second signal strength from a second transmitting UE;
calculating difference value between the first signal strength and the second signal strength;
transmitting, to the first transmitting UE, a signal requesting a change of a resource to be used for communication with the first transmitting UE, based on the first specific value and the difference value;
communicating with the first transmitting UE with the changed resource.

8. The method of claim 7,
wherein the step of transmitting, to the first transmitting UE, a signal requesting a change of a resource to be used for communication with the first transmitting UE is performed only when the difference value is equal to or greater than a second specific value.

9. The method of claim 7,
wherein the first signal strength and the second signal strength are measured based on RSRP (Reference Signal Receive Power).

10. The method of claim 7, further comprising:
receiving instruction to measure the first signal strength and the second signal strength from the transmitting UE.

11. The method of claim 7,
wherein the first specific value is based on parameters such as the number of demodulation levels, the number of layers, and subcarrier spacing of the signal to be transmitted by the first transmitting UE to the first receiving UE.

12. The method of claim 7, further comprising:
monitoring, by the first receiving UE, a connection quality of a beam pair used for transmission and reception;
transmitting a beam management trigger to the first transmitting UE, based on the connection quality.

13. The method of claim 12,
wherein the step of transmitting a beam management trigger to the first transmitting UE comprises:
transmitting a value of the beam management trigger which is designated as 1 when the connection quality is below a certain value;
transmitting a value of the beam management trigger which is designated as 0 when the connection quality is greater than a certain value.

14. A first transmitting UE for communicating with a first receiving UE comprising:
a transceiver; and
a processor allocating resource;
wherein the processor receives a measurement report from the first receiving UE,
wherein the measurement report includes result of the first receiving UE measuring a first signal strength from the first transmitting UE and a second signal strength from a second transmitting UE;
wherein the processor determines whether to change a resource for allocation to be used for communication with the first receiving UE, based on a difference between the first signal strength and the second signal strength;
wherein the processor performs communication by allocating resource for communication with the first receiving UE.

15. The first transmitting UE of claim 14,
wherein the processor determines to change a resource for allocation only when the difference between the first signal strength and the second signal strength is greater than or equal to a specific value.

16. The first transmitting UE of claim 14,
wherein the first signal strength and the second signal strength are measured based on RSRP (Reference Signal Receive Power).

17. The first transmitting UE of claim 14,
wherein the processor transmits instruction to measure the first signal strength and the second signal strength to the first receiving UE.

18. The first transmitting UE of claim 14,
wherein the transceiver transmits information on the number of wide beams and the number of narrow beams to the first receiving UE;
wherein the transceiver receives information on a window section for beam management from the first receiving UE;
wherein the step of performing communication by allocating resource for communication with the first receiving UE comprises performing beam sweeping to determine an optimal beam pair.

19. The first transmitting UE of claim 14,
wherein the transceiver receives beam management trigger from the first receiving UE,
wherein the processor allocates resource by performing beam management.

20-21. (canceled)
